(19) United States
(12) Patent Application Publication
(10) Pub. No.: US 2024/0192511 A1
(43) Pub. Date: Jun. 13, 2024

(54) Wearable Devices

(71) Applicant: APPLE INC., Cupertino, CA (US)

(72) Inventors: Paul X. Wang, Cupertino, CA (US); Dustin A. Hatfield, Los Gatos, CA (US); Liam R. Martinez, San Francisco, CA (US); Kristine S. Atom, Sunnyvale, CA (US); Adam Y. Kollgaard, Santa Cruz, CA (US); Benjamin A. Shaffer, San Jose, CA (US); Joshua A. Hoover, Boulder, CO (US); Jenna L. Withrow, San Francisco, CA (US); Robert V. Tang, San Francisco, CA (US); Kendall L. Helbert, San Francisco, CA (US); Geng Luo, Sunnyvale, CA (US)

(21) Appl. No.: 18/584,146

(22) Filed: Feb. 22, 2024

Related U.S. Application Data
(63) Continuation of application No. PCT/US2022/043095, filed on Sep. 9, 2022.
(60) Provisional application No. 63/329,916, filed on Apr. 12, 2022.
(60) Provisional application No. 63/246,537, filed on Sep. 21, 2021.

(51) Int. Cl. G02B 27/01

(52) U.S. Cl. CPC G02B 27/0176

(57) ABSTRACT

A wearable device includes a support and a cushion that is coupled to the support, the cushion including a first portion and a second portion, the first portion having a first stiffness, the second portion having a second stiffness, and the first stiffness is at least four times greater than the second stiffness.

### CROSS-REFERENCE TO RELATED APPLICATIONS

This application is a continuation of International Application PCT/US2022/043095, filed on Sep. 9, 2022, which claims the benefit of U.S. Provisional Application No. 63/246,537, filed on Sep. 21, 2021. International Application PCT/US2022/043095 also claims the benefit of U.S. Provisional Application No. 63/329,916, filed on Apr. 12, 2022. The contents of the foregoing applications are hereby incorporated by reference herein in their entireties for all purposes.

### TECHNICAL FIELD

This disclosure relates to wearable devices and, in particular, physical interfaces that allow the devices to be worn by a user.

### BACKGROUND

Wearable devices are worn by users and perform various functions, such as outputting content and tracking fitness related information. These devices are supported by the body of the user, which can lead to discomfort for some users.

### SUMMARY

A first aspect of the disclosure is a facial interface for a head-mounted display unit that includes a first portion and a second portion. The first portion has a first stiffness and is configured to engage an upper facial region above the eyes of the user. The second portion has a second stiffness and is configured to engage one or more of a lower facial region below the eyes of the user or side facial regions outside the eyes of the user. The first stiffness is at least four times greater than the second stiffness. The facial interface is configured to continuously engage the upper facial region, the lower facial region, and the side facial regions around the eyes of the user to block environmental light from the eyes of the user.

In some implementations of the facial interface according to the first aspect of the disclosure, the facial interface includes third portions having a third stiffness and being configured to engage the side facial regions, wherein the first stiffness is at least four times greater than the third stiffness, and the second portion is configured to engage the lower facial region. The first portion may include a right upper subportion having the first stiffness, a left upper subportion having the first stiffness, and a central upper subportion having a fourth stiffness, the first stiffness being at least four times greater than the fourth stiffness. The right upper subportion and the left upper subportion may be configured to engage, respectively, a right upper facial subregion and a left upper facial subregion above, respectively, a right eye and a left eye of the eyes of the user. The central upper subportion may be configured to engage with the fourth stiffness a central upper facial subregion between the right upper facial subregion and the left upper facial subregion. In some implementations of the facial interface according to the first aspect of the disclosure, the second portion includes a right lower subportion having the second stiffness and a left lower subportion having the second stiffness, wherein the right lower subportion and the left lower subportion are configured to engage, respectively, a right lower facial subregion and a left lower facial subregion below, respectively, the right eye and the left eye of the user. In some implementations of the facial interface according to the first aspect of the disclosure, the second stiffness and the third stiffness are substantially equal.

In some implementations of the facial interface according to the first aspect of the disclosure, the first portion includes a right upper subportion having the first stiffness, a left upper subportion having the first stiffness, and a central upper subportion having a third stiffness, the first stiffness being at least four times greater than the third stiffness. The right upper subportion and the left upper subportion may be configured to engage, respectively, a right upper facial subregion and a left upper facial subregion above, respectively, a right eye and a left eye of the eyes of the user. The central upper subportion may be configured to engage a central upper facial subregion between the right upper facial subregion and the left upper facial subregion.

In some implementations of the facial interface according to the first aspect of the disclosure, the second portion includes a third stiffness that is at least four times greater than the second stiffness, wherein the second portion is configured to engage the lower facial region through an initial range of travel of between two and seven millimeters and after the initial range of travel. The second portion may include a deformable core having a rearward layer of a first foam material having a first modulus of elasticity that provides the second stiffness and also having a forward layer of a second foam material having a second modulus of elasticity that provides the third stiffness.

In some implementations of the facial interface according to the first aspect of the disclosure, the facial interface includes a chassis, a deformable core coupled to and positioned rearward of the chassis, and a flexible cover extending over and rearward of the deformable core. The deformable core may include a first foam material having a first modulus of elasticity that provides the first stiffness and a second foam material having a second modulus of elasticity that provides the second stiffness, the first modulus of elasticity being at least four times greater than the second modulus of elasticity. The first foam material may form the deformable core of the first portion, and the second foam material may form the deformable core of the second portion. The first foam material and the second foam material may overlap each other with varying thicknesses to gradually change between the first stiffness and the second stiffness. The various features of the first aspect can be implemented together or separately.

A second aspect of the disclosure is a head-mounted display that includes a display unit having a chassis and one or more displays coupled to the chassis for providing graphical content to a user wearing the head-mounted display, a head support coupled to the display unit and configured to engage a head of the user to support the display unit thereon, and a facial interface coupled to the display unit and configured to engage a face of the user to support the display unit thereon. The facial interface is configured to continuously engage an upper facial region above eyes of the user, a lower facial region below the eyes, and side facial regions to sides of the eyes of the user to surround the eyes to block environmental light therefrom. The head support and the facial interface are cooperatively configured to apply a first pressure with the facial interface to the upper facial region that is at least four times greater than a second pressure applied by the facial interface to the lower facial region.

In some implementations of the head-mounted display according to the second aspect of the disclosure, the head support and the facial interface are cooperatively configured for the first pressure to be at least four times greater than a third pressure applied by the facial interface to the side facial regions. The facial interface may include an upper portion having a first stiffness and configured to engage the upper facial region and a lower portion having a second stiffness and configured to engage the lower facial region, the first stiffness being at least four times greater than the second stiffness. The head support may extend between left and right sides of the chassis of the display unit and may be configured to extend around and engage the head of the user, and the head support may apply rearward force to the chassis that forms a line of action extending through the upper portion of the facial interface and the upper facial region.

In some implementations of the head-mounted display according to the second aspect of the disclosure, the head support and the facial interface are cooperatively configured for the first pressure to be at least four times greater than a third pressure applied by the facial interface to the side facial regions. In some implementations of the head-mounted display according to the second aspect of the disclosure, the facial interface includes an upper portion having a first stiffness and configured to engage the upper facial region and a lower portion having a second stiffness and configured to engage the lower facial region, the first stiffness being at least four times greater than the second stiffness. In some implementations of the head-mounted display according to the second aspect of the disclosure, the head support extends between left and right sides of the chassis of the display unit and is configured to extend around and engage the head of the user, and the head support applies rearward force to the chassis that forms a line of action extending through the upper facial region. The various features of the second aspect can be implemented together or separately.

A third aspect of the disclosure is a facial interface system for a head-mounted display. The facial interface system includes a first modular component configured to engage with a first stiffness an upper facial region of a face of a user wearing the head-mounted display and a second modular component configured to engage with a second stiffness a lower facial region of a face of a user wearing the head-mounted display, the first stiffness being at least four times greater than the second stiffness. The first modular component and the second modular component are removably coupleable independent of each other to a chassis of one of the facial interface system or a display unit of the head-mounted display

Some implementations of the facial interface system according to the third aspect of the disclosure include a cover that covers and is arranged to rearward sides of the first modular component and the second modular component, wherein the first modular component is selectable from a first group of modular components that differ by curvature of a rearward surface thereof configured to engage the upper facial region, and the second modular component is selectable from a second group of modular components that differ by thickness in an axial direction.

In some implementations of the facial interface system according to the third aspect of the disclosure, the first modular component is selectable from a first group of modular components that differ by curvature of a rearward surface thereof configured to engage the upper facial region. In some implementations of the facial interface system according to the third aspect of the disclosure, the second modular component is selectable from a second group of modular components that differ by thickness in an axial direction. Some implementations of the facial interface system according to the third aspect of the disclosure include a cover that covers and is arranged to rearward sides of the first modular component and the second modular component. The various features of the third aspect can be implemented together or separately.

A fourth aspect of the disclosure is a wearable device that includes a support and a cushion that is coupled to the support. The cushion includes a first portion and a second portion, the first portion has a first stiffness, the second portion has a second stiffness, and the first stiffness is at least four times the second stiffness.

In some implementations of the wearable device according to the fourth aspect of the disclosure, the first portion of the cushion includes a first foam material that provides the first stiffness, and the second portion of the cushion includes a second foam material that provides the second stiffness. The first foam material and the second foam material may have different densities and may be formed from a common material type. The first foam material and the second foam material may be formed from different material types.

In some implementations of the wearable device according to the fourth aspect of the disclosure, the cushion includes a first foam layer and a second foam layer, the first foam layer and the second foam layer cooperate to provide the first stiffness in the first portion of the cushion, and the first foam layer provides the second stiffness in the second portion of the cushion. The cushion may have a consistent depth in the first portion of the cushion and in the second portion of the cushion, and the second foam layer may be not present in the second portion of the cushion.

In some implementations of the wearable device according to the fourth aspect of the disclosure, the cushion includes a transition portion having a gradual stiffness transition between the first stiffness and the second stiffness. The first portion of the cushion may include a first foam material that provides the first stiffness, the second portion of the cushion may include a second foam material that provides the second stiffness, and the first foam material may overlap the second foam material in the transition portion to define the gradual stiffness transition between the first stiffness and the second stiffness. The various features of the fourth aspect can be implemented together or separately.

A fifth aspect of the disclosure is a wearable device that includes a support and a cushion that is coupled to the support. The cushion includes a first portion having a first stiffness, a second portion, and voids formed in the second portion so that the second portion has a second stiffness that is less than the first stiffness.

In some implementations of the wearable device according to the fifth aspect of the disclosure, the cushion includes a foam material that provides the first stiffness in the first portion of the cushion, and the foam material and the voids cooperate to provide the second stiffness in the second portion of the cushion. The voids may extend through the foam material from a front surface of the foam material to the support. The voids may extend partially through the foam material.

In some implementations of the wearable device according to the fifth aspect of the disclosure, the cushion includes a transition portion in which the voids are configured to define a gradual stiffness transition between the first stiffness and the second stiffness. The voids may have varying depths in the transition portion. The voids have may have varying spacings in the transition portion. The various features of the fifth aspect can be implemented together or separately.

A sixth aspect of the disclosure is a wearable device that includes a support and a cushion that is coupled to the support. The cushion includes a molded foam structure having a first portion and a second portion, the first portion having a first density, and the second portion having a second density, wherein the first stiffness is greater than the second density.

In some implementations of the wearable device according to the sixth aspect of the disclosure, the molded foam structure is formed by compressing a first foam layer and a second foam layer so that the first foam layer is located in the first portion of the cushion and in the second portion of the cushion, and the second foam layer is located in first portion of the cushion and is not located in the second portion of the cushion. In some implementations of the wearable device according to the sixth aspect of the disclosure, the molded foam structure is formed by compressing a foam layer having a variable thickness and a consistent density to define a consistent thickness and variable density for the molded foam structure. In some implementations of the wearable device according to the sixth aspect of the disclosure, the molded foam structure has a front surface and a back surface, a molded depression is formed in the back surface of the molded foam structure, and the support has a support feature that extends into the molded depression to provide support for the first portion of the cushion.

A seventh aspect of the disclosure is a wearable device that includes a support, and a cushion that is coupled to the support. The cushion is configured to engage an upper facial region, a lower facial region, and side facial regions to block environmental light. The cushion includes a first portion that is configured to engage the upper facial region, the first portion having a first stiffness, a second portion configured to engage the lower facial region, the second portion having a second stiffness, and the first stiffness is at least four times greater than the second stiffness, and third portions that are configured to engage the side facial regions.

In some implementations of the wearable device according to the seventh aspect, the third portions have a third stiffness, the first stiffness being at least four times greater than the third stiffness. In some implementations of the wearable device according to the seventh aspect, the first portion includes a right upper subportion having the first stiffness, a left upper subportion having the first stiffness, and a central upper subportion having a fourth stiffness, the first stiffness being at least four times greater than the fourth stiffness. The right upper subportion and the left upper subportion are configured to engage, respectively, a right upper facial subregion and a left upper facial subregion above, respectively, a right eye and a left eye. The central upper subportion is configured to engage with the fourth stiffness a central upper facial subregion between the right upper facial subregion and the left upper facial subregion. The second portion includes a right lower subportion having the second stiffness and a left lower subportion having the second stiffness, wherein the right lower subportion and the left lower subportion are configured to engage, respectively, a right lower facial subregion and a left lower facial subregion below, respectively, the right eye and the left eye of the user.

In some implementations of the wearable device of the seventh aspect of the disclosure, the first portion of the cushion includes a first foam material that provides the first stiffness, and the second portion of the cushion includes a second foam material that provides the second stiffness. The first foam material and the second foam material may have different densities and may be formed from a common material type. The first foam material and the second foam material may be formed from different material types. The cushion may include a first foam layer and a second foam layer, where the first foam layer and the second foam layer cooperate to provide the first stiffness in the first portion of the cushion, and the first foam layer provides the second stiffness in the second portion of the cushion. The cushion may have a consistent depth in the first portion of the cushion and in the second portion of the cushion, and the second foam layer is not present in the second portion of the cushion. In some implementations of the wearable device of the seventh aspect of the disclosure, the cushion includes a transition portion having a gradual stiffness transition between the first stiffness and the second stiffness. In some implementations of the wearable device of the seventh aspect of the disclosure, the first portion of the cushion includes a first foam material that provides the first stiffness, the second portion of the cushion includes a second foam material that provides the second stiffness, and the first foam material overlaps the second foam material in the transition portion to define the gradual stiffness transition between the first stiffness and the second stiffness.

In some implementations of the wearable device of the seventh aspect of the disclosure, voids are formed in the second portion to define the second stiffness. The cushion may include a foam material that provides the first stiffness in the first portion of the cushion, and the foam material and the voids cooperate to provide the second stiffness in the second portion of the cushion. The voids may extend through the foam material from a front surface of the foam material to the support. The voids may extend partially through the foam material. The cushion may include a transition portion in which the voids are configured to define a gradual stiffness transition between the first stiffness and the second stiffness. In some implementations of the wearable device of the seventh aspect of the disclosure, the cushion includes a molded foam structure having the first portion and the second portion, the first portion having a first density, and the second portion having a second density, wherein the first density is greater than the second density. The various features of the seventh aspect can be implemented together or separately.

### BRIEF DESCRIPTION OF THE DRAWINGS

FIG. 1 is a schematic view of a head-mounted display unit.

FIG. 2 is a schematic view of an example hardware configuration of a controller 122 of the head-mounted display unit of FIG. 1.

FIG. 3 is a top view of the head-mounted display unit being worn on a head of a user.

FIG. 4 is a front view of the head-mounted display unit on the head of the user.

FIG. 5 is a right side view of the head-mounted display unit on the head of the user.

FIG. 6 is a front view of the head of the user identifying facial regions and subregions.

FIG. 7 is a right side view of the head of the user identifying the facial regions and subregions.

FIG. 8 is a rear view of a facial interface of the head-mounted display unit.

FIG. 9 is a cross-sectional view of a head support of the head-mounted display unit taken along lines 9-9 in FIG. 5.

FIG. 10 is a cross-sectional view of a first configuration of the facial interface taken along line 10-10 in FIG. 8.

FIG. 11 is a cross-sectional view of a second configuration of the facial interface taken along line 11-11 in FIG. 8.

FIG. 12 is a cross-sectional view of a second configuration of the facial interface taken along line 12-12 in FIG. 8.

FIG. 13 is a cross-sectional view of the facial interface taken along line 13-13 in FIG. 8.

FIG. 14 is a rear view of a facial interface system having a first modular component and a second modular component.

FIG. 15 is a rear view of another facial interface system having five modular components.

FIG. 16 is a top view of multiple versions of the first modular component of FIG. 14 having different curvatures.

FIG. 17 is a top view of multiple versions of the second modular component of FIG. 15 having different thicknesses.

FIG. 18 is a block diagram of a wearable device.

FIG. 19A is a cross-section schematic illustration of part of a chassis of the wearable device of FIG. 18 according to a first example.

FIG. 19B is a cross-section schematic illustration, taken along line 19-19 of FIG. 19A, of the chassis of FIG. 19A.

FIG. 19C is a cross-section schematic illustration, taken along line 19-19 of FIG. 19A, of an alternative implementation of the chassis of FIG. 19A.

FIG. 20A is a cross-section schematic illustration of part of a chassis of the wearable device of FIG. 18 according to a second example.

FIG. 20B is a cross-section schematic illustration of part of a chassis of the wearable device of FIG. 18 according to a third example.

FIG. 20C is a cross-section schematic illustration of part of a chassis of the wearable device of FIG. 18 according to a fourth example.

FIG. 21A is a front schematic illustration of part of a chassis of the wearable device of FIG. 18 according to a fifth example.

FIG. 21B is a cross-section schematic illustration, taken along line 21-21 of FIG. 21A, of the chassis of FIG. 21A.

FIG. 21C is a cross-section schematic illustration, taken along line 21-21 of FIG. 21A, of an alternative implementation of the chassis of FIG. 21A.

FIG. 21D is a cross-section schematic illustration, taken along line 21-21 of FIG. 21A, of an alternative implementation of the chassis of FIG. 21A.

FIG. 21E is a cross-section schematic illustration, taken along line 21-21 of FIG. 21A, of an alternative implementation of the chassis of FIG. 21A.

FIG. 21F is a cross-section schematic illustration, taken along line 21-21 of FIG. 21A, of an alternative implementation of the chassis of FIG. 21A.

FIG. 21G is a cross-section schematic illustration, taken along line 21-21 of FIG. 21A, of an alternative implementation of the chassis of FIG. 21A.

FIG. 21H is a front schematic illustration of an alternative implementation of the chassis of FIG. 21A.

FIG. 22A is a cross-section schematic illustration of part of a chassis of the wearable device of FIG. 18 according to a sixth example.

FIGS. 22B-22C are schematic illustrations showing a first implementation of a molding operation for forming a cushion of the chassis of FIG. 22A.

FIGS. 22D-22E are schematic illustrations showing a first implementation of a molding operation for forming the cushion of the chassis of FIG. 22A.

FIG. 23A is a cross-section schematic illustration of part of a chassis of the wearable device of FIG. 18 according to a seventh example.

FIGS. 23B-23C are schematic illustrations showing an implementation of a molding operation for forming the cushion of the chassis of FIG. 23A.

FIG. 24 is a cross-section schematic illustration of part of a chassis of the wearable device of FIG. 18 according to an eighth example.

FIG. 25 is a schematic illustration showing an example implementation of the wearable device of FIG. 18.

FIG. 26 is a schematic illustration showing an example implementation of the wearable device of FIG. 18.

FIG. 27 is a schematic illustration showing an example implementation of the wearable device of FIG. 18.

### DETAILED DESCRIPTION

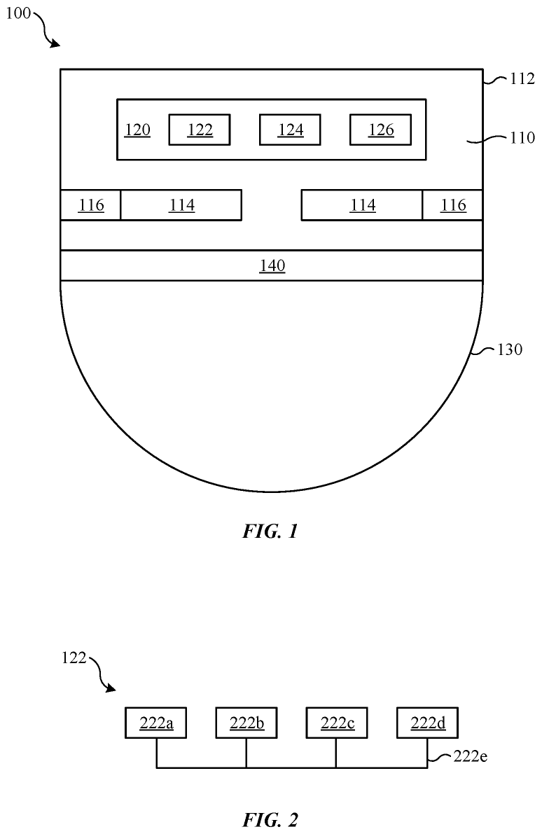

Referring to FIG. 1, a head-mounted display unit 100 is depicted schematically. The head-mounted display unit 100 generally includes a display unit 110, electronics 120, a head support 130, and a facial interface 140.

The display unit 110 is configured output graphical and/or audio content to the user, for example, as part of a simulated reality experience as described in further detail below. The display unit 110 generally includes a chassis 112, a display 114 (e.g., one or more displays), and speakers 116 (e.g., one or more speakers). The chassis 112 is the primary structure that is coupled to and supports the display 114 in position for outputting (e.g., displaying) graphical content to a user wearing the head-mounted display unit 100. More particularly, the chassis 112 is a generally rigid structure configured to support the display 114 relative to eyes of the user (e.g., in front of the eyes of the user). The chassis 112 may, for example, be configured as a housing that extends around (above, below, and to the sides) of the eyes of the user and defines a rear opening disposed toward the face of the user and through which the display 114 is viewable by the user. The display 114 is configured to output graphical content to the user. The display 114 may, for example, example include a display panel (e.g., liquid crystal (LCD), light emitting diode (LED), organic LED (OLED)) or projector that outputs the graphics and any associated optical components (e.g., lenses, reflectors) by which the graphics are provided to the user. The speakers 116 are configured to output the audio content to the user. The speakers 116 may be coupled to the chassis 112 or in other embodiments may be coupled to the head support 130.

The electronics 120 are configured to generate or otherwise provide the graphical and/or audio content. The electronics 120 may, for example, include a controller 122 (e.g., one or more controllers), sensors 124 (e.g., one or more sensors), and power electronics 126, which may be physically coupled to the chassis 112 of the display unit 110 (as shown) or be provided physically separate therefrom (e.g., being electrically coupled thereto and/or in communication therewith via a wired and/or wireless connection). The controller 122 is configured to control the display 114, the speakers 116, and/or the other electronics 120 (e.g., the sensors 124 and/or the power electronics 126). The controller 122 is discussed in further detail below. The sensors 124 are in communication with the controller 122 and configured to sense the environment, sense the user, and/or receive communication signals from other devices. The controller 122 controls the output of display 114 and/or the speakers 116 according to the sensors 124. The power electronics 126 are configured to store and/or provide electrical power for operating the display 114, the speakers 116, and the other electronics 120 (e.g., the controller 122 and the sensors 124) and may, for example, include a battery.

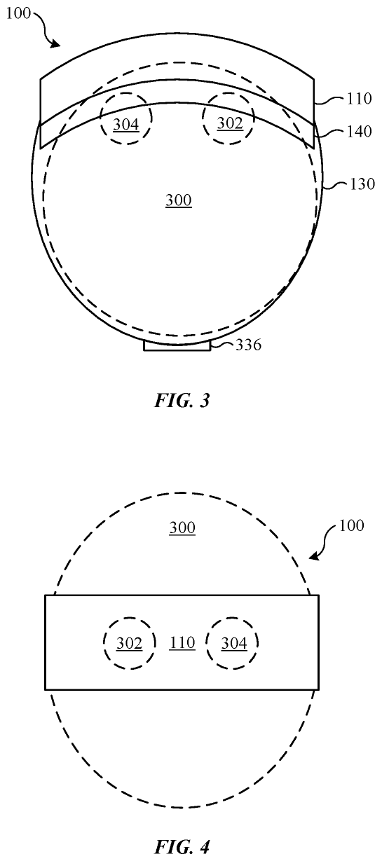

Referring to FIG. 2, an example hardware configuration is illustrated schematically for the controller 122. It should be noted, however, that the controller 122 may be any suitable computing device having any other suitable hardware configuration capable of performing the functions and methods described herein (e.g., to provide the graphical output according to the sensors 124). The controller 122 generally includes a processor 222a, a memory 222b, a storage 222c, a communications interface 222d, and a bus 222e by which the other components of the controller 122 are in communication with each other. The processor 222a may be any suitable processing device, such as a central processing unit (CPU) configured to execute instructions, such as software programming, for operating the display unit 110. The memory 222b is a short term, volatile storage device, such as a random-access memory (RAM) module). The storage 222c is a long-term, non-volatile storage device configured to store the instructions to be executed by the processor 222a and other information. The communications interface 222d is configured to send and/or receive signals (e.g., for operating the display 114 and/or to receive information from the sensors 124).

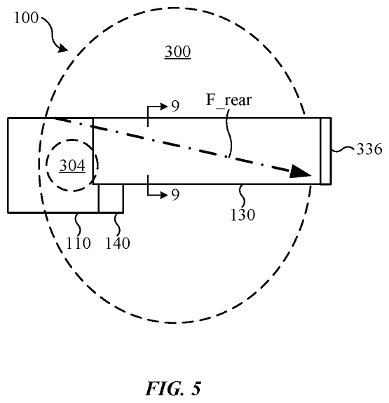

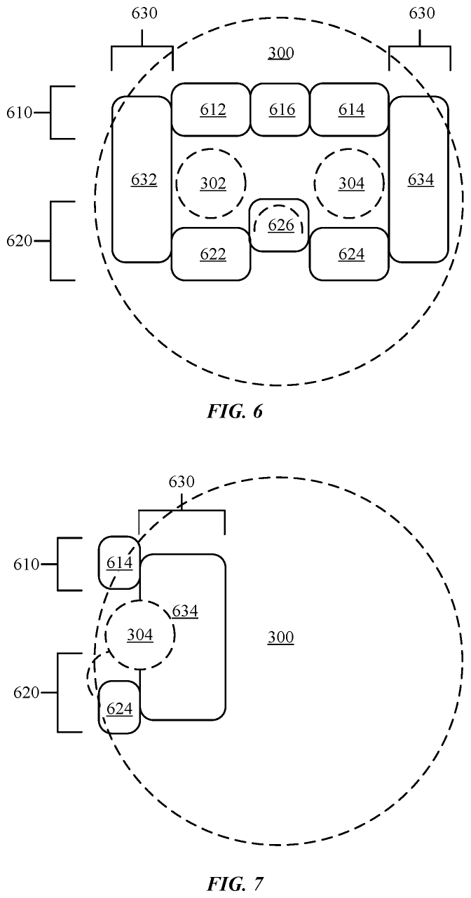

Referring to FIGS. 3-5, top, front, and right side views are shown of a user wearing the head-mounted display unit 100 on the head 300 thereof. The head support 130 is configured to engage the head 300 of the user to support the display unit 110 thereon. The head support 130 extends between left and right sides of the display unit 110 and around the head 300 of the user. The head support 130 is, for example, configured as a band that is adjustable and/or deformable to the shape and size of the head 300 of the user and/or according to comfort preferences of the user. For example, the head support 130 may be manually or automatically (e.g., via springs or elasticity of material forming the head support 130) extendable, so as to change a length of the head support 130 and/or the tension (e.g., force) by which the head support 130 pulls the display unit 110 toward the face of the user. For example, the head support 130 may include an adjustment device 336 discussed in further detail below.

The facial interface 140 is configured to engage the face of the user to support the display unit 110 thereon. The facial interface 140 coupled to a rearward side of the chassis 112 of the display unit 110 and engages the face of the user. The facial interface 140, or portions thereof, are compressed between display unit 110 and the face of the user by the force applied by the head support 130 between the head 300 of the user and the display unit 110. The facial interface 140 may be further configured to engage the face of the user to block environmental light from reaching the right eye 302 and the left eye 304 of the user. As discussed in further detail below, the facial interface 140 is configured to provide comfort to users wearing the head-mounted display unit 100 by applying different pressures to different regions of the face of the user.

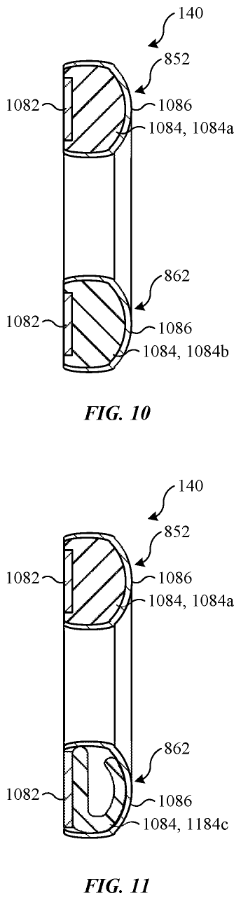

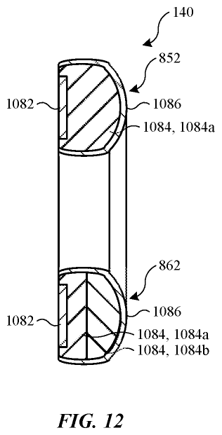

Referring to FIGS. 6-7, front and right side views of a head 300 of a user are shown. The head 300 generally includes an upper facial region 610, a lower facial region 620, and side facial regions 630. The upper facial region 610 generally includes the forehead region that is formed by the frontal bone of the head 300 of the user. The upper facial region 610 extends horizontally at least between positions vertically above centers of the right eye 302 and the left eye 304 but may also be considered to extend horizontally between positions vertically above the outer sides of the right eye 302 and the left eye 304, or between positions horizontally outward of the right eye 302 and the left eye 304. The upper facial region 610 may be considered to include a right upper facial subregion 612 that is positioned above the right eye 302 of the user, a left upper facial subregion 614 that is positioned above the left eye 304 of the user, and a central upper facial subregion 616 that is positioned above the glabella (e.g., above the nose) of the user. The right upper facial subregion 612, the left upper facial subregion 614, and the central upper facial subregion 616 may be considered to include regions of the forehead vertically above centers of the right eye 302, the left eye 304, and the nose, respectively, of the user. The right upper facial subregion 612 and the left upper facial subregion 614 may also be considered to extend horizontally between positions vertically above outer and inner sides of the right eye 302 and the left eye 304, or between positions horizontally outward and inward of each of the right eye 302 and the left eye 304.

The lower facial region 620 extends horizontally at least between positions vertically below centers of the right eye 302 and the left eye 304 but may also be considered to extend horizontally between positions vertically below the outer sides of the right eye 302 and the left eye 304, or between positions horizontally outward of the right eye 302 and the left eye 304. The lower facial region 620 may be considered to include a right lower facial subregion 622 that is positioned below the right eye 302 of the user (e.g., including the right cheek formed by the right zygomatic and maxillary bones), a left lower facial subregion 624 that is positioned below the left eye 304 of the user (e.g., including the left cheek formed by the left zygomatic and maxillary bones), and a central lower facial subregion 626 that may include the nose of the user (e.g., formed by the nasal bones). The right lower facial subregion 622 and the left lower facial subregion 624 may be considered to include regions of the face vertically below the right eye 302 and the left eye 304, respectively, of the user. The right lower facial subregion 622 and left lower facial subregion 624 may also be considered to extend horizontally between positions vertically below outer and inner sides of the right eye 302 and the left eye 304 but not the nose, or between positions horizontally outward and inward of each of the right eye 302 and the left eye 304.

The side facial regions 630 include a right side facial subregion 632 and a left side facial subregion 634. The right side facial subregion 632 generally includes the right temple of the user and is positioned to right of the right eye 302 of the user, generally extending between the right upper facial subregion 612 and the right lower facial subregion 622 (e.g., being formed generally by the frontal bone, the parietal bone, and the right sphenoid and temporal bones). The left side facial subregion 634 generally includes the left temple of the user and is positioned to the left of the left eye 304 of the user, generally extending between the left upper facial subregion 614 and the left lower facial subregion 624 (e.g., being formed generally by the frontal bone, the parietal bone, and the left sphenoid and temporal bones).

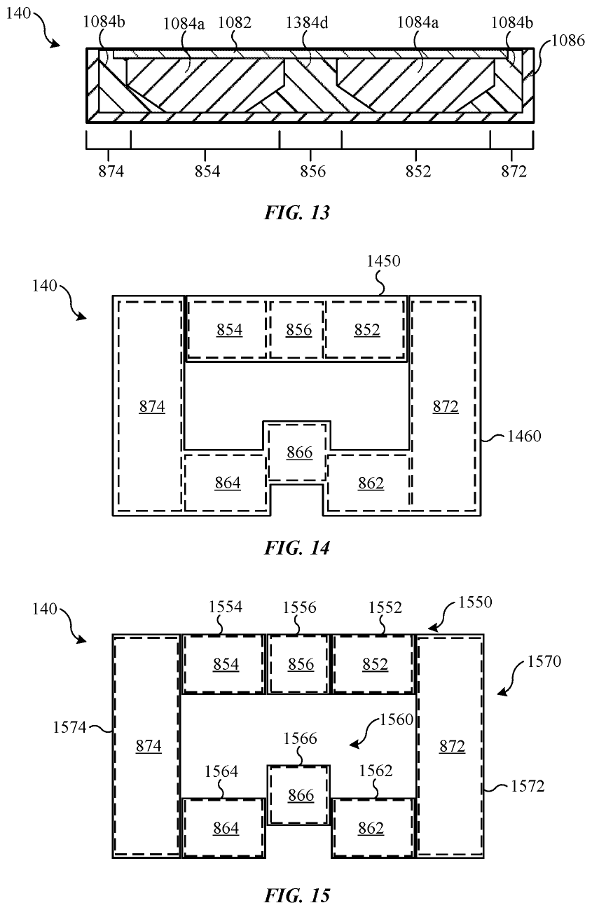

Referring to FIG. 8, which is a rear view of the head-mounted display unit 100, the facial interface 140 includes portions that correspond to and may further engage the different facial regions. The facial interface 140 may, for example, include an upper portion 850, a lower portion 860, and side portions 870 that correspond to and engage the upper facial region 610, the lower facial region 620, and the side facial regions 630, respectively, of the user. The upper portion 850 of the facial interface 140 may include a right upper subportion 852, a left upper subportion 854, and a central upper subportion 856 that correspond to and engage the right upper facial subregion 612, the left upper facial subregion 614, and the central upper facial subregion 616 of the upper facial region 610 of the user. The lower portion 860 of the facial interface 140 may include a right lower subportion 862, a left lower subportion 864, and a central lower subportion 866 that correspond to and engage the right lower facial subregion 622, the left lower facial subregion 624, and the central lower facial subregion 626 of the lower facial region 620 of the user. The side portions 870 may include a right side portion 872 and a left side portion 874 that correspond to and engage the right side facial subregion 632 and the left side facial subregion 634 of the side facial regions 630 of the user.

Furthermore, the facial interface 140 block environmental light from reaching the eyes of the user, for example, forming an opaque structure that substantially continuously engages the face of the user around the right eye 302 and the left eye 304. For example, the upper portion 850, the lower portion 860, and the side portions 870 may be configured to cooperatively engage the upper facial region 610, the lower facial region 620, and the side facial regions 630 substantially continuously around the right eye 302 and the left eye 304 of the user to prevent environmental light from passing thereto. Substantial continuous engagement in this context refers to sufficient contact to prevent the environment light from reaching the eyes of the user and/or contact along 90%, 95% or more of a trace surrounding the right eye 302 and the left eye 304 of the user.

Subjective experiences suggest that different regions of the face of the user may be less susceptible to discomfort for users than other regions from use of the head-mounted display unit, such as prolonged contact and support of head-mounted displays. For example, the upper facial region 610 may be less susceptible to discomfort for users than the lower facial region 620 and/or the side facial regions 630 from prolonged contact and support of head-mounted displays. Additionally, the right upper facial subregion 612 and the left upper facial subregion 614 may be less susceptible to discomfort for users than the central upper facial subregion 616.

The facial interface 140 is configured such that when in a standard position, the facial interface 140 applies different pressures to different regions and/or subregions of the face to provide comfort to the user. The standard position may be defined as the head 300 of the user being erect, facing forward (e.g., as if looking at the horizon or within 15 vertical degrees thereof), and not moving, with the facial interface 140 engaging the face of the user around the right eye 302 and the left eye 304.

The facial interface 140 may be configured that, when in the standard position, pressure applied by the upper portion 850 to the upper facial region 610 (i.e., the upper pressure P_upper) is greater than pressure applied by the lower portion 860 to the lower facial region 620 (i.e., the lower pressure P_lower), such as four, five, ten, twenty, or more times greater). For example, when the head support 130 is in tension and applies five newtons of force to the display unit 110 (e.g., generally equally divided to each side thereof), the upper pressure P_upper may be 0.8 psi or more (e.g., between 0.8 and 1.2 psi, or 1 psi or more), while the lower pressure P_lower may be 0.2 psi or less (e.g., 0.1 psi or less).

Instead or additionally, the facial interface 140 may be configured that, when in the standard position, pressure applied by the right upper subportion 852 to the right upper facial subregion 612 (i.e., the right upper pressure P_right_upper) is greater than pressure applied by the right lower subportion 862 to the right lower facial subregion 622 (i.e., the right lower pressure P_right lower), such as four, five, ten, twenty, or more times greater). For example, when the head support 130 is in tension and applies five newtons of force to the display unit 110 (e.g., generally equally divided to each side thereof), the right upper pressure P_right_upper may be 0.8 psi or more (e.g., between 0.8 and 1.2 psi, or 1 psi or more), while the right lower pressure P_right_lower may be 0.2 psi or less (e.g., 0.1 psi or less).

Instead or additionally, the facial interface 140 may be configured that, when in the standard position, pressure applied by the left upper subportion 854 to the left upper facial subregion 614 (i.e., the left upper pressure P_left_upper) is greater than pressure applied by the left lower subportion 864 to the left lower facial subregion 624 (i.e., the left lower pressure P_left_lower), such as four, five, ten, twenty, or more times greater). For example, when the head support 130 is in tension and applies five newtons of force to the display unit 110 (e.g., generally equally divided to each side thereof), the left upper pressure P_left_upper may be 0.8 psi or more (e.g., between 0.8 and 1.2 psi, or 1 psi or more), while the left lower pressure P_left_lower may be 0.2 psi or less (e.g., 0.1 psi or less).

Instead or additionally, the facial interface 140 may be configured such that when in the standard position, the upper pressure P_upper is greater than pressure applied by the side portions 870 to the side facial regions 630 (i.e., the side pressure P_side), such as four, five, ten, twenty, or more times greater). For example, when the head support 130 is in tension and applies five newtons of force to the display unit 110 (e.g., generally equally divided to each side thereof), the upper pressure P_upper may be 0.8 psi or more (e.g., between 0.8 and 1.2 psi, or 1 psi or more), while the side pressure P_side may be 0.2 psi or less (e.g., 0.1 psi or less).

Instead or additionally, the facial interface 140 may be configured such that when in the standard position, the right upper pressure P_right_upper and the left upper pressure P_left_upper are each greater than pressure applied by the central upper subportion 856 to the central upper facial subregion 616 of the face (i.e., the central upper pressure P_central_upper), such as 1.5, two, three, four, five, ten, twenty, or more times greater. For example, when the head support 130 is in tension and applies five newtons of force to the display unit 110 (e.g., generally equally divided to each side thereof), the right upper pressure P_right_upper and the left upper pressure P_left_upper may each be 0.8 psi or more (e.g., between 0.8 and 1.2 psi, or 1 psi or more), while the central upper pressure P_central_upper may be 0.6 psi or less (e.g., 0.4 psi, 0.2 psi, 0.1 psi or less).

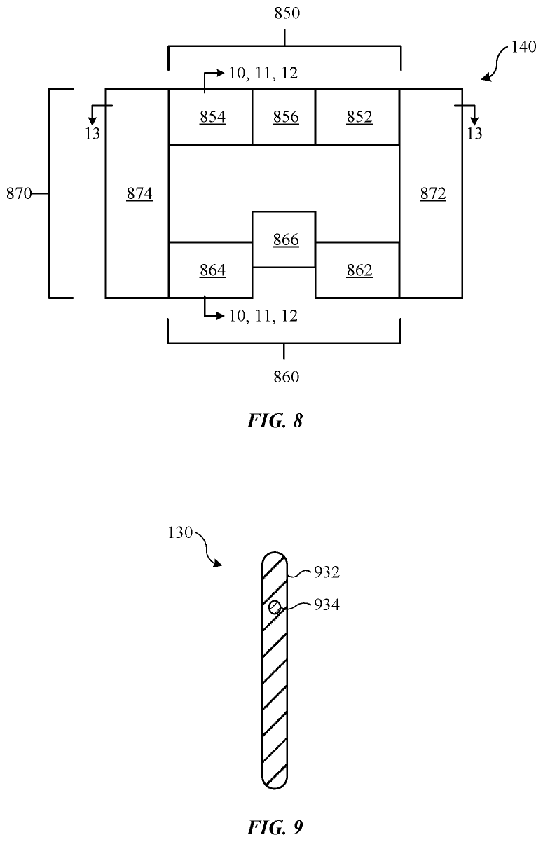

Referring again to FIG. 5, the head support 130 is configured cooperatively with the facial interface 140 to apply the different pressures with the facial interface to the different regions of the face. More particularly, the head support 130 is coupled to and applies rearward force to upper locations on each of the left and right side of the chassis 112 such that a line of action (indicated by the force vector F_rear) extends through the upper facial region 610 (e.g., the right upper facial subregion 612 and the left upper facial subregion 614, or frontal bone) to the rear part of the head (e.g., formed by the parietal and/or occipital bones). The line of action is the net force applied by the head support 130 to the display unit 110. As compared to a lower line of action, having the line of action from the head support 130 extending through the upper facial region 610 or subregions thereof to the back of the head 300, a moment about a pivot formed between the upper portion 850 of the facial interface and the upper facial region 610 may be reduced to so as to lessen the pressure applied by the facial interface 140 to the lower facial region 620 and/or the side facial regions 630. This pivot location may be referred to as the forehead pivot.

The head support 130 may be substantially flexible about a horizontal lateral axis (i.e., extending left to right). As a result, the head support 130 may apply negligible torque to the display unit 110 that might otherwise counter torque about the forehead pivot caused by gravity or the rearward force acting on the display unit 110 from the head support 130. Rather, rotation about the forehead pivot is countered by the vertical distribution of the forward force applied by the upper facial region 610 to the facial interface 140 and/or a relatively low but non-zero forward force applied by the lower facial region 620 and/or the side facial regions 630 to the facial interface 140. It should be noted that while the head support 130 is depicted as being coupled to and applying the rearward force to the chassis 112 of the display unit adjacent the side facial regions 630 (e.g., proximate the temples of the user), the display unit 110 may include rigid portions that extend rearward thereof (e.g., toward or above the ears of the user) or the head support 130 may include rigid portions that rigidly attach to (i.e., to transfer torque to) and extend rearward of the chassis 112 (e.g., toward or above the ears of the user).

The head support 130 may be configured as a band having a height that is significantly greater than a thickness thereof, which may be to distribute force over the rear part of the head and/or provide a desired aesthetic. The line of action may, at or adjacent to the connection of the head support 130 to the chassis 112, be biased toward an upper edge of the band, for example, being located within 25%, 20%, 15% or less of the height of the band from the upper edge thereof.

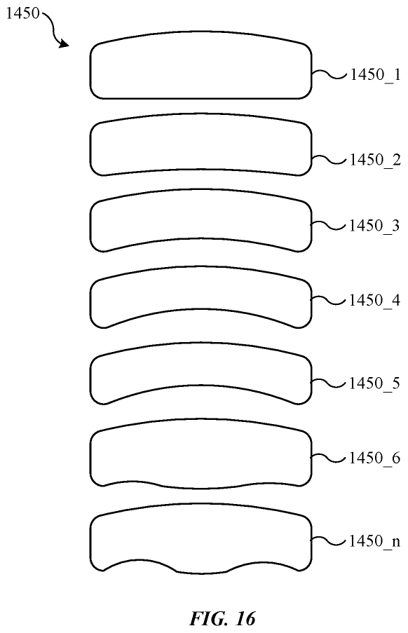

Referring additionally to the cross-sectional view of the head support 130 in FIG. 9, the head support 130 may include a first elongated part 932 and a second elongated part 934, each of which extend along sides of the head 300 of the user (e.g., from forward to rearward of the ears). The first elongated part 932 is flexible and has low elasticity so as to transfer a substantial majority (e.g., 80%, 90%, or more) of the rearward force from the head support 130 to the chassis 112 of the display unit 110. The first elongated part 932 may have a relatively small height compared to the overall height of the band or the second elongated part 934 (e.g., being 25%, 15%, 10% or less). The first elongated part 932 may vary in height by location relative to the second elongated part 934 extending rearward (e.g., starting at a forward portion of the head support 130 nearer to the upper edge of the second elongated part 934 end ending at a rearward portion of the head support 130 further from the upper edge, for example, following the of action). The first elongated part 932 may, for example, be a cord or a tape formed of a flexible and relatively inelastic material having a relatively high modulus of elasticity (e.g., Vectran). The first elongated part 932 and/or the line of action may extend downward moving rearward when in the standard position.

The second elongated part 934 may, for example, include an elastic textile, elastomer (e.g., silicone), or combination of materials that form the height of the band. The second elongated part 934 may cover the first elongated part 932 from view (e.g., extending over and/or surround the first elongated part). The first elongated part 932 is relatively elastic as compared to the first elongated part 932 (e.g., having a low modulus of elasticity), such that that the first elongated part 932 and the second elongated part 934 may move (e.g., translate) relative to each other as a length of the band is adjusted.

As noted previously, the length of the band may be adjusted. For example, referring again to FIGS. 3 and 5, the head support 130 may include an adjustment device 336 that may be passively operated (e.g., via springs) or manually operated (e.g., via a dial, clamp, ratchet) to adjust the length of the band (e.g., the first elongated part 932) and/or the tension therein and, thereby, the rearward force to the chassis 112 of the display unit 110.

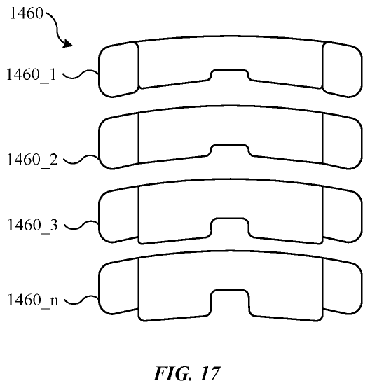

Referring to FIGS. 10-17, the different pressures applied to the different facial regions may be achieved by forming the facial interface 140 with various different structures and/or materials with different stiffnesses to engage the face of the user. The stiffness of the various portions and structures of the facial interface determines the force and pressure applied to the face of the user by the facial interface 140. Furthermore, the facial interface 140 may be provided in different versions to account for different shapes of facial structures for different people (e.g., age and/or ethnicity).

Referring to FIG. 10, in one configuration, the facial interface 140 generally includes a chassis 1082, a deformable core 1084, and a cover 1086. The chassis 1082 is a structure by which the facial interface 140 is coupleable (e.g., removably coupleable) to the display unit (e.g., with magnetic and/or mechanical coupling devices). The deformable core 1084 is coupled to the chassis 1082 and formed of a compressible material (e.g., foam, flexible elastomer, and/or fluid-filled elastomer) having characteristics that change between the different portions of the facial interface 140 to provide the different stiffnesses to achieve different pressures (e.g., such characteristics being modulus of elasticity, density, thickness, and/or geometry). The cover 1086 is formed of a flexible material that generally or wholly covers the deformable core 1084 from view, and forms the outer surface of the facial interface 140 that contacts the face of the user. The cover 1086 may, for example, be formed of a knit material (e.g., textile), an elastomeric sheet material, or other type of material (e.g., a molded elastomer, such as silicone, or foam material). The cover 1086 may also be referred to as a membrane. The cover 1086 may be configured to itself (i.e., absent the deformable core 1084) transfer negligible additional force from the display unit 110 to the face of the user, for example, being thin and flexible. The cover 1086 may also be omitted in which case the deformable core 1084 directly engages the face of the user.

In the example shown in FIG. 10, a deformable core 1084 of each of the upper portion 850 and the lower portion 860 has a substantially solid cross-sectional shapes formed by different foam materials having different moduli of elasticity and/or densities. The different foam materials may be any suitable type of flexible foam material (e.g., closed- or open-cell foam rubber, polyurethane foam, elastomeric foam).

The substantially solid cross-sectional shapes of the deformable core 1084 of each of the upper portion 850 and the lower portion 860 provide that the foam material extends substantially continuously in a normal (e.g., forward) direction from the face of the user (e.g., as opposed having a hollow cross-sectional shape or a curved cross-sectional shape intended to deflect in addition to compressing). As shown, the cross-sectional shape is generally convex, curving outward toward in the rearward direction toward the face of the user, but may instead be flat. For example, the upper portion 850 (e.g., the right upper subportion 852, the left upper subportion 854, and/or the central upper subportion 856) includes a first foam material 1084a that forms the deformable core 1084 that is positioned adjacent the cover 1086 or which directly engages the upper facial region 610 (e.g., the right upper facial subregion 612, the left upper facial subregion 614, and/or the central upper facial subregion 616). The lower portion 860 (e.g., the right lower subportion 862, the left lower subportion 864, and/or the central lower subportion 866) includes a second foam material 1084b that is positioned adjacent the cover 1086 or which directly engages the cover 1086. The first foam material 1084a (indicated by large cross-hatching) has a modulus of elasticity and/or density that is four, five, ten, twenty or more times greater than those of the second foam material 1084b (indicated by small cross-hatching). As a result of the different moduli of elasticity and/or densities of the first foam material 1084a and the second foam material 1084b, the upper portion 850 or subportions thereof have a stiffness that is four, five, ten, twenty or more times greater than that of the lower portion 860 or subportions therebelow.

The right upper subportion 852, the left upper subportion 854, and the central upper subportion 856 each including (e.g., being formed of) foam material having the same modulus of elasticity and/or density (e.g., the first foam material 1084a), or the right upper subportion 852 and the left upper subportion 854 may include (e.g., be formed of) the first foam material 1084a that has the first modulus of elasticity and/or density, while the central upper subportion 856 may include (e.g., be formed of) another foam material (e.g., the second foam material 1084b or a third foam material having a lower modulus of elasticity and/or density than those of the first foam material). For example, the modulus of elasticity and/or density of the third foam material may be between those of the first foam material 1084a and the second foam material 1084b. As a result, a stiffness of the central upper subportion 856 may be lower than that of the right upper subportion 852 and the left upper subportion 854 and may further be greater than that of the lower portion 860 or subportions thereof.

The side portions 870 (e.g., the right side portion 872 and/or the left side portion 874) may also have substantially solid cross-sectional shapes (not shown) formed by a foam material, which may be the second foam material 1084b or another foam material having a third modulus of elasticity and/or density. In the case of the other foam material, the modulus of elasticity and/or density of the first foam material 1084a may be four, five, ten, twenty or more times greater than those of the other foam material. As a result of the different moduli of elasticity and/or densities of the foam materials, the upper portion 850 of subportions thereof have a stiffness that is four, five, teen, twenty or more times greater than that of the right side portion 872 and the left side portion 874.

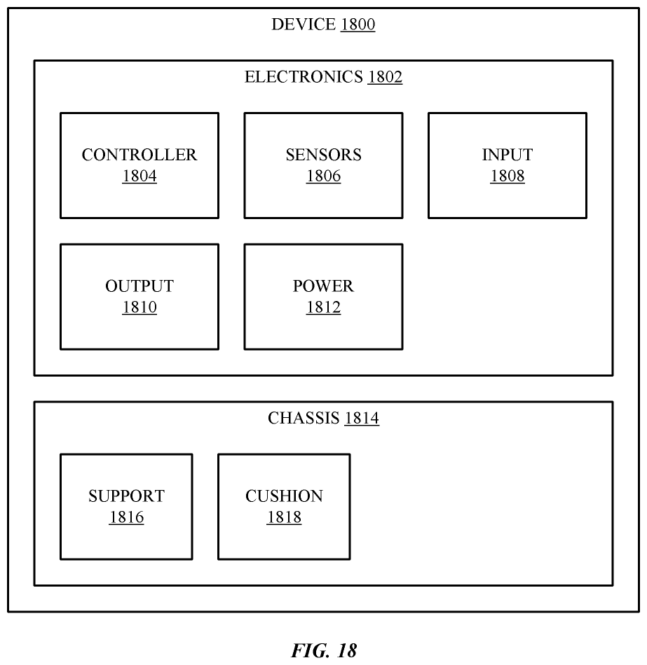

Referring to FIG. 11, in another example, the upper portion 850 (e.g., the right upper subportion 852, the left upper subportion 854, and/or the central upper subportion 856) has a substantially solid cross-sectional shape formed of a compressible material (e.g., foam), while the lower portion 860 has a discontinuous cross-sectional shape 1184c formed by an elastomeric material (e.g., the first foam material 1084a). The substantially solid cross-sectional shape is as described above. The discontinuous cross-sectional shape 1184c provides that the elastomeric material thereof does not extend substantially continuously in the normal (e.g., forward direction) from the face of the user, such that the deformable core 1084 deflects (e.g., bends) as force is applied thereto instead of or in addition to compressing. The discontinuous cross-sectional shape 1184c may, for example, include an L-shape or C-shape (as shown) having a rearward leg formed by the material and a void (e.g., air) forward of the rearward leg (i.e., away from the user) or be hollow. The material and geometry (i.e., the discontinuous cross-sectional shape 1184c) are configured to provide a stiffness to the lower portion 860, which the stiffness of the upper portion 850 is four, five, ten, twenty, or more times greater than.

The side portions 870 (e.g., the right side portion 872 and/or the left side portion 874) may have substantially solid cross-sectional shapes formed by a foam material having a lower stiffness and/or density than the first foam material (as described above) or may have a discontinuous cross-sectional shape (e.g., being L-shaped, C-shaped, or hollow) as described above for the lower portion 860), which provides the side portions 870 with a stiffness, which the stiffness of the upper portion 850 is four, five, ten, twenty, or more times greater than.

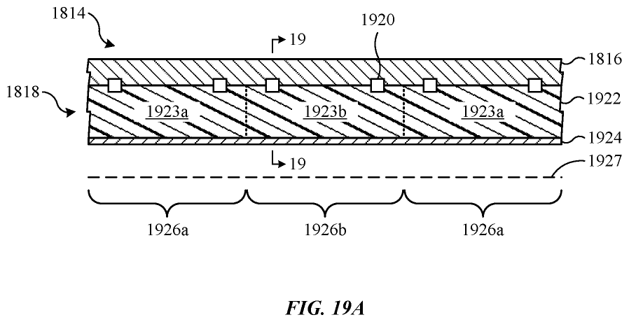

Referring to FIG. 12, the upper portion 850 of the facial interface 140 may be configured as described previously with respect to FIG. 10. The lower portion 860 (shown) and/or the side portions 870 (not shown) include the deformable core 1084 that is formed with foam materials having different elastic moduli and/or densities that increase moving forward (i.e., from adjacent the face of the user toward the display unit 110). For example, the deformable core 1084 may include a rearward layer formed of the second foam material 1084b and a forward layer formed of the first foam material 1084a (i.e., having an elastic modulus and/or density that is four, five, ten, twenty, or more times greater than those of the second foam material 1084b). The rearward layer of the second foam material 1084b may, for example, be between two and ten millimeters thick (i.e., measured in the axial or forward direction), such as between three and seven millimeters thick. The forward layer of the first foam material 1084a may have any suitable thickness (e.g., between two and ten mm). As a result, the lower portion 860 and/or the side portions 870 provide increasing stiffness as they are compressed against the face of the user (e.g., increasing in stiffness by four, five, ten, twenty, or more times greater after being compressed an initial range of travel of more than seven mm, five mm, three millimeters or less, or between two and seven millimeters).

In each of the embodiments shown in FIGS. 11 and 12, the lower portion 860 (e.g., the right lower subportion 862 and the left lower subportion 864) and/or the side portions 870 (e.g., the right side portion 872 and the left side portion 874) have variable stiffness in an axial (forward) direction. By having variable stiffness, and in particular by increasing in stiffness moving forward, lower pressure can be applied by the facial interface 140 to the face of the user when in the standard position and higher pressure may applied when in non-standard positions or circumstances, so as to distribute such higher pressure over the facial structures and prevent localized transfer of force from the display unit 110 to the face of the user. Such non-standard positions or circumstances may include the user moving abruptly or the head-mounted display unit 100 impacting or being impacted by another object. In either scenario, the head-mounted display unit 100 and, in particular, the display unit 110 moves relative to the face of the user and to cause non-static forces of higher magnitude than in the standard position to be applied by the facial interface 140 to the face of the user. In still other embodiments, the deformable core 1084 may exhibit variable stiffness, for example, by being formed of or including a material that exhibits non-linear modulus of elasticity (e.g., forming a bladder containing a non-Newtonian fluid).

It should be noted that the configuration of the lower portion 860 and/or side portions 870 illustrated in FIG. 11 may provide similar functionality of increasing stiffness above a range of compression to that shown in FIG. 12. For example, discontinuous cross-sectional shape 1184c may be formed of the first foam material 1084a, while the void may be between two and ten millimeters in the axial direction (i.e., measured in the axial or forward direction), such as between three and seven millimeters. As the deformable core 1084 is compressed, the void is reduced and the rearward leg of the discontinuous cross-sectional shape 1184c presses against the forward leg thereof, thus resulting in the stiffness of the foam material.

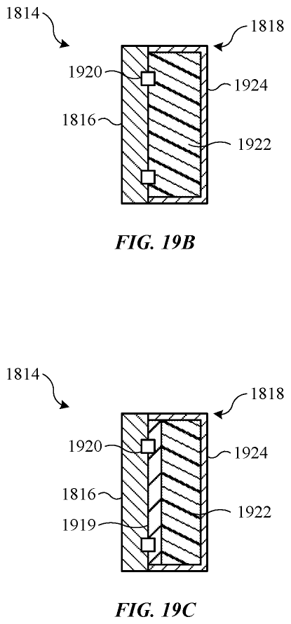

Referring to FIG. 13, as the facial interface 140 transitions between different portions or subportions, the different materials and/or geometries may change abruptly moving from one portion to the other circumferentially around the right eye 302 and the left eye 304 of the user or may change gradually. For example, in the case of adjacent portions of the facial interface 140 having different foam materials with different moduli of elasticity and/or densities (e.g., the upper portion 850 having different materials than the side portions 870, or the right upper subportion 852 and the left upper subportion 854 having different materials than the central upper subportion 856), the different foam materials may overlap to cooperatively form an overall thickness of the deformable core 1084 measured in the normal direction and to each individually reduce in thickness. In one case, the stiffer and/or denser foam material (e.g., the first foam material 1084a) may be positioned rearward of the other material (i.e., closer to the face of the user; e.g., the second foam material 1084b and/or the third foam material 1384d) or may be positioned forward of the other material (i.e., further from the face of the user). As such, the pressure and force applied to the face of the user may change gradually moving from one facial region to another (e.g., from the upper facial region 610 to the side facial regions 630 and/or from the right upper facial subregion 612 and the left upper facial subregion 614 to the central upper facial subregion 616).

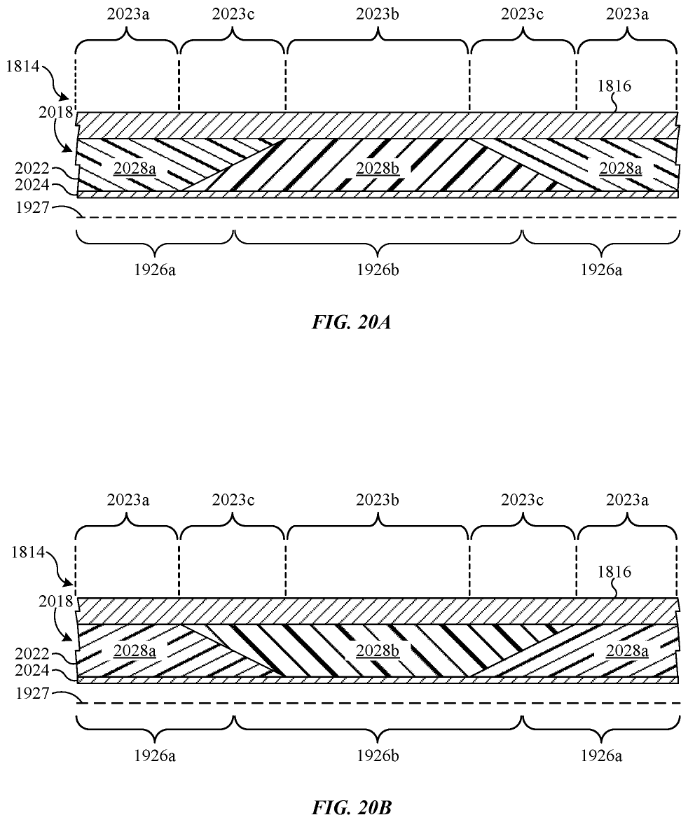

Referring to FIGS. 14-17, the facial interface 140 and/or individual portions thereof are removably coupleable to the display unit 110 and may be interchangeable with other facial interfaces that are equivalent to the facial interface 140 and/or portions thereof, so as to account for different facial shapes and/or sizes and/or preferences of users. Facial shapes may vary by ethnicity, age, and other considerations. The shape of the upper facial region 610 (e.g., the forehead) may vary from being rounder to flatter. The shape of the lower facial region 620 (e.g., the left and right cheeks) may vary by the relative axial (e.g., forward) position to the upper facial region 610 thereabove. The shape of the upper facial region 610 and/or the lower facial region 620 may also vary from side to side (e.g., the curvatures and/or forward positions thereof).

To account for these different shapes of faces, different versions of the facial interface 140 may be interchangeable with each other. For example, the different versions of the facial interface 140 may have different combinations of curvature of the upper portion 850 (i.e., to account for the different forehead curvatures) and different thicknesses of the lower portion 860 (i.e., to still engage the lower facial region 620 with low pressure while accounting for different forward positions of the lower portion 860).

Referring to FIG. 14, the facial interface 140, or a facial interface system, includes an upper modular component 1450 and a lower modular component 1460. The upper modular component 1450 and the lower modular component 1460 cooperatively surround the right eye 302 and the left eye 304 of the user. For example, the upper modular component 1450 may be configured as described above for the upper portion 850 of the facial interface 140, while the lower modular component 1460 may be configured as described above for the lower portion 860 and the side portions 870 (i.e., a module having the combination thereof).

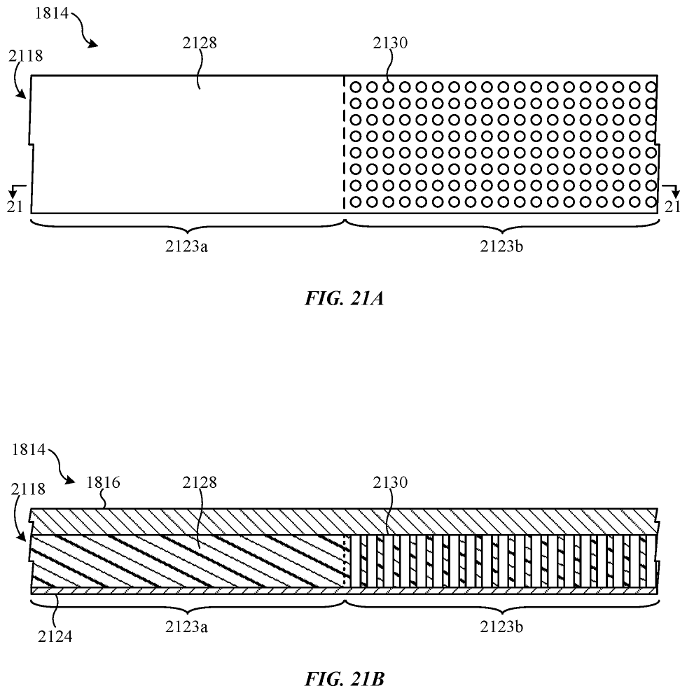

Referring to FIG. 16, the upper modular component 1450 is selected from a group of several different versions of the upper modular component 1450_1 to 1450_n that have different shapes (e.g., curvatures on rearward surfaces). For example, the curvatures in the horizontal direction on the rearward surfaces of the different versions of the upper modular component 1450_1 to 1450_n may range from flatter to more curved (e.g., concave) as shown with the versions of the different versions of the upper modular component 1450_1 to 1450_5 and/or by multiple curves of varying concavity on either side of a protrusion as shown with the versions of the different versions of the upper modular component 1450_6 to 1450_7. Each of the different versions of the upper modular component 1450_1 to 1450_n is interchangeable with other of the different versions of the upper modular component 1450_1 to 1450_n to be coupleable to the chassis 1082 of the facial interface 140 or directly to the display unit 110 to form the upper portion 850 of the facial interface 140. Each of the different versions of the upper modular component 1450 is configured as described above for the upper portion 850 (e.g., including the right upper subportion 852, the left upper subportion 854, and/or the central upper subportion 856 described above). It is noted that, as shown with the different versions of the upper modular component 1450_6 to 1450_n, the center protrusion may be used to help locate (e.g., center) the display unit 110 on the face of the user. Instead or additionally, the different versions of the upper modular component 1450_1 to 1450_n may vary in material properties (e.g., stiffness) and/or cross-sectional shape.

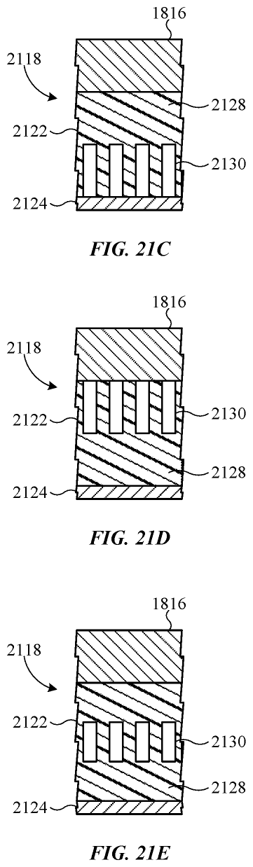

Referring to FIG. 17, the lower modular component 1460 is selected from a group of several different versions of the lower modular component 1460 that vary by having different thicknesses, so as to account for different forward positions of the lower facial region 620 for the facial interface 140 to extend rearward from the display unit 110 and contact the lower facial region 620. For example, the thicknesses range from shallower to deeper as shown with the versions of the lower modular component 1460_1 to 1460_n. Each of the different versions of the lower modular component 1460 is interchangeable with each of the other different versions of the lower modular component 1460 to be coupleable to the chassis 1082 of the facial interface 140 or directly to the display unit 110 to form both the lower portion 860 and the side portions 870 of the facial interface 140. The lower modular component 1460 is configured as described above for lower portion 860 (e.g., including the right lower subportion 862, the left lower subportion 864, and the central lower subportion 866 described above) and the side portions 870.

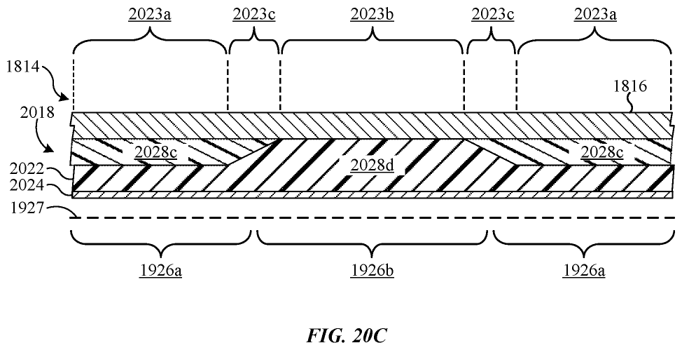

Referring to FIG. 15, the facial interface 140 includes multiple upper modules 1550 (e.g., a right upper module 1552, a left upper module 1554, and a central upper module 1556) and includes one of the different versions of the lower modular component 1460 described above (i.e., forming the lower portion 860 and the side portions 870 of the facial interface 140) or may include multiple lower modules 1560 (e.g., a right lower module 1562, a left lower module 1564, and a central lower module 1566) and/or multiple side modules 1570 (e.g., a right side module 1572 and a left side module 1574). Each of the multiple upper modules 1550 is selected from groups of different ones of the upper modules 1550 having different curvatures and/or thicknesses and which are removably coupleable to the chassis 1082 of the facial interface 140 and which vary by curvature and/or thickness.

The multiple lower modules 1560 form one or more of the portions or subportions of the facial interface 140 described previously. Each of the multiple lower modules 1560 and/or the multiple side modules 1570 is selected from groups of different ones of the lower modules 1560 and different ones of the side modules 1570 having different thicknesses. While the lower multiple lower modules 1560 and the multiple side modules 1570 are depicted as having one module for each of the facial regions, the one of the multiple lower modules 1560 may be configured to correspond to multiple of the lower facial regions and/or one of the multiple side modules 1570 may be configured to correspond to one or more of the side facial regions 630 and/or one or more subregions of the lower facial region 620. For example, a left module (not shown) may correspond to the left lower facial subregion 624 and the left side facial subregion 634 and a right module (not shown) may correspond to the right lower facial subregion 622 the right side facial subregion 632.

In the case of different interchangeable modules forming the facial interface 140, each individual module may include the cover 1086, or alternatively, the cover 1086 may be a singular cover that selectively covers (e.g., receives therein and/or is moved over) the different modules forming the facial interface 140.

It should be noted that while various different portions and subportions of the facial interface, regions and subregions of the faces of users, and/or other features or components may generally be identified directionally (e.g., upper, lower, left, right, central, side), such portions, subportions, regions, and subregions may instead be identified numerically or in other manners to distinguish therebetween, for example, in the claims. For example, the upper portion 850, the lower portion 860, and the side portions 870 of the facial interface 140 may instead be referred to, respectively, as first, second, and third portions. Furthermore, such different portions and regions may be referred to cooperatively or aggregately. For example, the lower portion and the side portions 870 may be referred to cooperatively as a second portion.

The facial interface 140, or the modules forming the facial interface system, may be formed in any suitable manner. For example, the chassis 1082 may be formed of a metal, plastic, or combination thereof (e.g., insert or overmolded). Coupling features may be formed with or otherwise coupled the chassis 1082, such as magnets, springs, or clips that correspond to mating coupling features on the display unit 110 (e.g., the chassis 112 thereof). The deformable core 1084 may be formed in any suitable manner (e.g., injection molding) from any suitable material (e.g., the foam materials described previously) and/or an elastomer (e.g., silicone or rubber). The deformable core 1084 may be overmolded or insert molded to the chassis 1082 or otherwise coupled (e.g., adhered thereto). The cover 1086 may be formed in any suitable manner from any suitable material. For example, in the case of the cover 1086 being formed of a woven material (e.g., a soft textile), the material may be woven according to any appropriate pattern. In another example, the cover 1086 may be formed of an extruded elastomer or may be molded. The cover 1086 may be fixedly coupled to the deformable core 1084 and/or the chassis 1082 (e.g., being overmolded, insert molded, or adhered thereto). In other embodiments, the cover 1086 and/or the deformable core 1084 (e.g., the modules) may be detachable from each other.

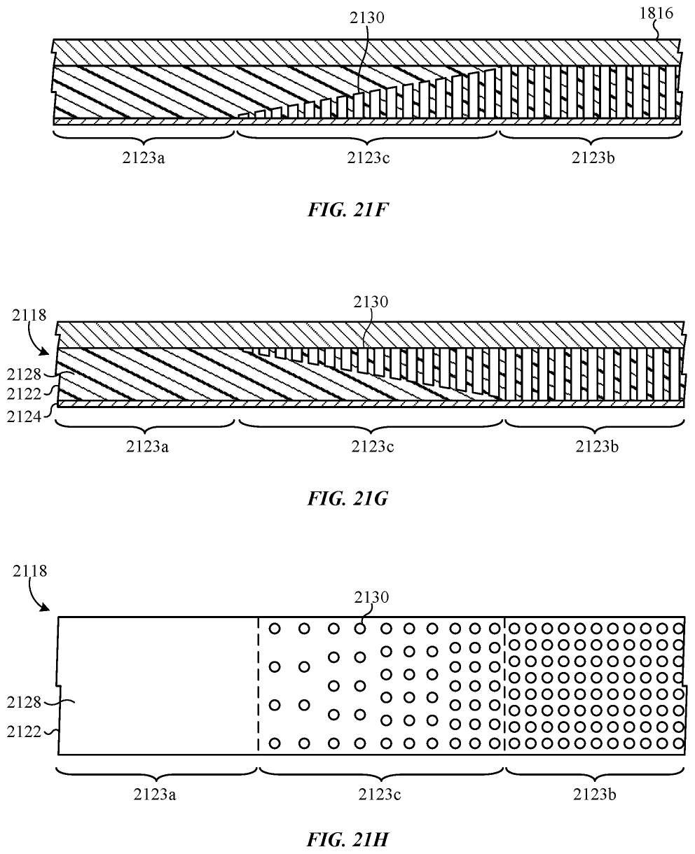

The concepts described with respect to FIGS. 1-17 may be implemented in the context of other types of wearable devices. Further implementations described in FIGS. 18-27 may utilize the features and configurations described with respect to FIGS. 1-17 and the features and configurations described with respect to FIGS. 18-27 may be incorporated in the facial interfaces described with respect to FIGS. 1-17.

FIG. 18 is a block diagram of a wearable device 1800. The wearable device 1800 is an electronic device that is intended to be worn by a user, for example, by inclusion of components that secure the wearable device 1800 to a port of a body of the user, such as the head, wrist, upper arm, waist, leg, or ankle of the user. Examples of components that may be included in the wearable device 1800 include sensor components, input components, and output components. For example, the wearable device 1800 may be configured to present audio content and/or visual content to the user.

In the illustrated implementation, the wearable device 1800 includes electronics 1802, such as a controller 1804 (e.g., one or more controllers), sensors 1806 (e.g., one or more sensors), input components 1808 (e.g., one or more input components), output components 1810 (e.g., one or more output components), and power electronics 1812.

The controller 1804 may include circuits, processors, devices, and other components that implement the functionality of the wearable device 1800, such as by collecting information from the sensors 1806 and/or the input components 1808 and/or by controlling presentation of audio content and/or visual content using the output components 1810. As an example, the controller 1804 may be implemented according to the description of the controller 122, inclusive of the processor 222a, the memory 222b, the storage 222c, the communications interface 222d, and the bus 222e.

The sensors 1806 are components that provide inputs to the electronics 120, such as measurements that describe states of the wearable device 1800, states of the user, and/or states of the environment in which the wearable device 1800 is operating. Examples of sensor components that may be included in the sensors 1806 include visible spectrum cameras, infrared cameras, infrared emitters, depth cameras, structured-light sensing devices, accelerometers, gyroscopes, magnetometers, and biometric sensors such as a heart rate sensor, a respiration sensors, a fingerprint scanner, a retinal scanner, and a face scanner. The sensors 1806 may, for example, be implemented according to the description of the sensors 124. The input components 1808 may include microphones, buttons, a keyboard, a mouse, a touch sensing device, a gesture sensing device, and/or other types of input devices. The output components 1810 may include audio output devices, such as loudspeakers (e.g., such as the speakers 116), and visual output devices such as indicator lights and display screens (e.g., such as the display 114). The output components 1810 may be used to output audio content such as music. The output components 1810 may be used to output visual content such as a video. The output devices may include optical components that are configured as a near-eye display (e.g., lenses, reflectors, polarizers, filters, optical combiners, and/or other optical components) that is able to output simulated reality content to the user. The power electronics 1812 are configured to provide electrical power to the components of the wearable device 1800, for example, by inclusion of a battery and charging circuitry. For example, the power electronics 1812 may be implemented according to the description of the power electronics 126.

The wearable device 1800 includes a chassis 1814. The chassis 1814 is a structure or assembly that is configured to physically support and interconnect the various components of the wearable device 1800. The chassis 1814 may be implemented in various forms, such as in the form of a housing, an enclosure, or a frame. The chassis includes a support 1816 and a cushion 1818 that cooperate to allow the user to wear the wearable device, such as by engaging the body of the user to support the wearable device 1800 with respect to the body of the user and, optionally, to secure the wearable device 1800 with respect to the body of the user (e.g., by restraining relative motion. The cushion 1818 is coupled to the support 1816 and is configured to engage a portion of the body of the user. The cushion 1818 is flexible and elastic (e.g., returns to its original shape when an external force is no longer applied. The support 1816 may be a portion of the chassis 1814 (such as a surface of the chassis) or a components that is connected to the chassis 1814. When the cushion 1818 is engaged with the body of the user, forces are reacted between the support 1816 and the body of the user through the cushion 1818 to support the wearable device 1800 (e.g., inclusive of the chassis 1814) with respect to the user.

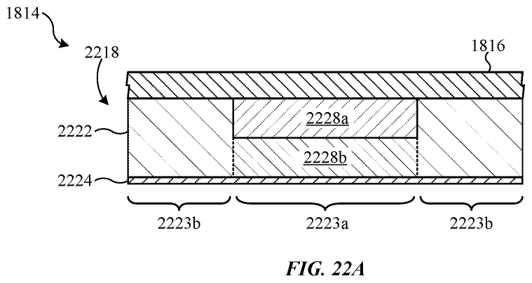

FIG. 19A is a cross-section schematic illustration of part of the chassis 1814 of the wearable device 1800 of FIG. 18 according to a first example, including the support 1816 and the cushion 1818 thereof. FIG. 19B is a cross-section schematic illustration, taken along line 19-19 of FIG. 19A, of the chassis 1814. The cushion 1818 is coupled to the support 1816, which in the illustrated implementation is a releasable connection that uses connectors 1920 that releasably connect the cushion 1818 to the support 1816.

The cushion 1818 is configured to engage the body of the user to comfortably support the wearable device 1800. In the illustrated implementation, the cushion includes a deformable core 1922 and a cover 1924. The deformable core 1922 is the primary component of a load path between the user and the support 1816, and is configured to deform according to engagement with the body of the user to conform to the body of the user to provide a comfortable physical interface with the wearable device. The deformable core 1922 may be configured in the manner described with respect to the deformable core 1084 and as further described herein. The cover 1924 is a flexible and elastic component that is located on and/or over all or part of the deformable core 1922 to define an exterior surface of the cushion 1818 may be configured in the manner described with respect to the cover 1086 and as further described herein. The cover 1924 and/or the deformable core 1922 may define smooth exterior surfaces or may incorporate a texture or geometric feature (e.g., channels or ridges) to increase grip and reduce sliding or to promote airflow between the cushion 1818 and the body of the user.

The cushion 1818 is comprised of two or more portions that have different stiffnesses. One of the portions of the cushion 1818 may have a stiffness that is, for example, two, four, five, ten, twenty, or more times greater than the stiffness of the other portion. As an example, the cushion 1818 may include a first portion and a second portion, the first portion having a first stiffness, the second portion having a second stiffness, and the first stiffness being at least four times the second stiffness. In the illustrated implementation, the deformable core 1922 of the cushion 1818 includes high stiffness portions 1923a and a low stiffness portion 1923b, where the stiffness of the high stiffness portions 1923a is, for example, two, four, five, ten, twenty, or more times greater than the stiffness of low stiffness portion 1923b. These portions may be arranged adjacent to each other along an exterior surface of the cushion 1818, for example, as defined by the cover 1924. For example, the low stiffness portion 1923b may be located between two of the high stiffness portions 1923a.

In the illustrated implementation, the positions of the high stiffness portions 1923a of the cushion 1818 correspond to first body regions 1926a of a body portion 1927 of the user, and the low stiffness portion 1923b of the cushion 1818 corresponds to a second body region 1926b of the body portion 1927 of the user. The high stiffness portions 1923a transfer a greater force per unit area between the body of the user and the wearable device 1800 than the low stiffness portion 1923b does, which allows the load of the wearable device 1800 to be distributed in a desired manner, for example, to achieve a desired weight distribution, to accommodate shapes of various body types, to avoid localized areas of high pressure application to the second body region 1926b, to avoid loading a sensitive area of the body of the user that is located in the second body region 1926b, or to avoid loading a protruding body feature (e.g., a bony ridge) of the body of the user that is located in the second body region 1926b in a way that would cause a pressure concentration.

The difference in stiffness of the high stiffness portions 1923a relative to the low stiffness portion 1923b may be accomplished in various ways. The deformable core 1922 of the cushion 1818 may include a first foam material that provides a first stiffness (e.g., a higher stiffness) in the high stiffness portions 1923a, and a second foam material that provides a second stiffness (e.g., a lower stiffness than the first stiffness) in the low stiffness portion 1923b. As one example, the first foam material and the second foam material may be formed from a common material type, such as from foam materials that have the same chemical composition, but having different densities from one another. As another example, the first foam material and the second foam material are formed from different material types, such as from two different types of foam materials that have differing chemical compositions. Examples of foam materials having different chemical compositions include silicone foams as compared to polyurethane foams. As another example, the first foam material and the second foam material may be formed having differing physical structures, such as a closed-cell structure as compared to an open-cell structure. Differing types of foam also allow other properties to differ by body region, such as by using foam material with different heat performance, breathability, and moisture wicking for different body regions.

The connectors 1920 may be two part structures that have complementary features that are connectable to and disconnectable from each other. The connectors 1920 may be, as examples, snap connectors, slide connectors, pins or posts held by a friction fit, hook and loop type connectors, other types of mechanical fasteners, or magnetic connectors. In the implementation shown in FIG. 19B, the connectors 1920 are attached to a rear surface (e.g., facing away from the user-contacting side) of the deformable core 1922. In an alternative implementation, as shown in FIG. 19C, the deformable core 1922 and the cover 1924 are mounted to a cushion frame 1919, and the connectors 1920 are mounted to the cushion frame 1919.

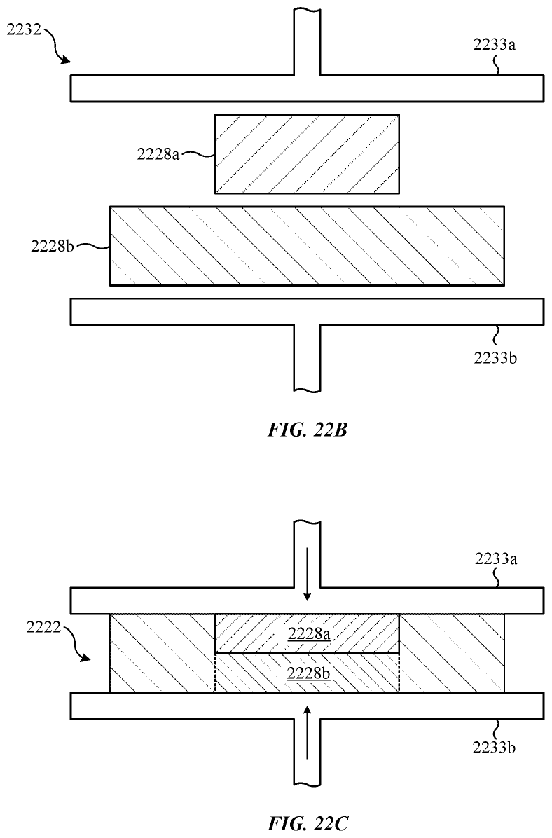

FIG. 20A is a cross-section schematic illustration of part of the chassis 1814 of the wearable device 1800 of FIG. 18 according to a second example, in which a cushion 2018, which is an implementation of the cushion 1818, and includes a deformable core 2022 having a high stiffness foam material 2028a and a low stiffness foam material 2028b, and also includes a cover 2024. The deformable core 2022 and a cover 2024 are equivalent to the deformable core 1922 and the cover 1924 except as described herein.

The high stiffness foam material 2028a and the low stiffness foam material 2028b of the deformable core 2022 are configured to define a gradual stiffness transition between high stiffness portions 2023a that include the high stiffness foam material 2028a, and a low stiffness portion 2023b that includes the low stiffness foam material 2028b. In particular, the high stiffness foam material 2028a overlaps the low stiffness foam material 2028b in transition portions 2023c to define the gradual stiffness transition by gradually changing between the first stiffness of the high stiffness portions 2023a and the second stiffness of the low stiffness portion 2023b. The overlap is achieved by defining a wedge like shape for each of the high stiffness foam material 2028a and the low stiffness foam material 2028b in the depth direction of the cushion 2018. The wedges of the high stiffness foam material 2028a and the low stiffness foam material 2028b overlap so that the stiffness within the transition portions 2023c is a function of the depth of the high stiffness foam material 2028a and the low stiffness foam material 2028b at a particular location. Outside the transition portions 2023c, the high stiffness foam material 2028a and the low stiffness foam material 2028b may each have a consistent depth (e.g., a depth equal to the distance between the cover 2024 and the support 1816). The orientation of the wedges may be changed to provide desired stiffness characteristics.

In the implementation shown in FIG. 20A, the wedge shapes defined by the low stiffness foam material 2028b are oriented so that a wide side of the low stiffness foam material 2028b faces the body portion 1927 of the user and a narrow side of the low stiffness foam material 2028b faces the support 1816 so that the low stiffness foam material 2028b is closer to the body portion 1927 of the user than the high stiffness foam material 2028a in the transition portions 2023c. A third example implementation of the chassis 1814, shown in FIG. 20B, is similar to the implementation of FIG. 20A, but the orientation of the wedges is reversed so that the high stiffness foam material 2028a are closer to the body portion 1927 of the user than the low stiffness foam material 2028b in the transition portions 2023c.

FIG. 20C is a cross-section schematic illustration of part of the chassis 1814 of the wearable device 1800 of FIG. 18 according to a fourth example in which the cushion 2018 includes a high stiffness foam material layer 2028c (e.g., a first foam layer) and a low stiffness foam material layer 2028d (e.g., a second foam material layer). The high stiffness foam material layer 2028c and the low stiffness foam material layer 2028d are both present in the high stiffness portions 2023a that are adjacent to the first body regions 1926a of the body portion 1927 of the user, but the high stiffness foam material layer 2028c is discontinuous and is not present in the low stiffness portion 2023b, which is adjacent to the second body region 1926b. Instead, only the low stiffness foam material layer 2028d is present adjacent to the second body region 1926b. In this configuration, the high stiffness foam material layer 2028c and the low stiffness foam material layer 2028d cooperate to provide the first stiffness in a first portion of the cushion 2018 (e.g., adjacent to the first body regions 1926a), and the low stiffness foam material layer 2028d provides the second stiffness in a second portion of the cushion 2018 (e.g., adjacent to the second body region 1926b. The cushion 2018 may have a consistent depth in both of the first portion and the second portion, but the high stiffness foam material layer 2028c is not present in the second portion, and instead, the low stiffness foam material layer 2028d defines the entire depth of the cushion 2018 (excluding the cover 2024) in the second portion. In the illustrated implementation, the transition portions 2023c may be defined by wedge shaped ends of the high stiffness foam material layer 2028c and a corresponding taper that is formed in the low stiffness foam material layer 2028d.

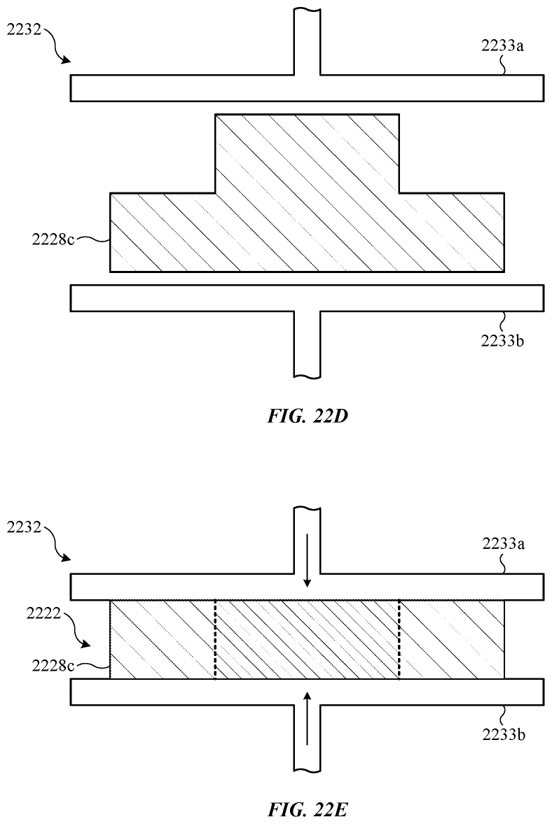

FIG. 21A is a front schematic illustration of part of the chassis 1814 of the wearable device 1800 of FIG. 18 and FIG. 21B is a cross-section schematic illustration of the chassis 1814 according to a fifth example, in which a cushion 2118, which is an implementation of the cushion 1818, has a deformable core 2122 with one or more variable stiffness regions defined by voids 2130. The cushion 2118 may also include a cover 2124 that surrounds part or all of the deformable core 2122 and may conceal the voids 2130 to present a smooth surface to the user and conceal the presence of the voids 2130. The deformable core 2122 and a cover 2124 are equivalent to the deformable core 1922 and the cover 1924 except as described herein.

The cushion 2118 includes a first portion 2123a having a first stiffness and a second portion 2123b having a second stiffness. The first stiffness is defined by a foam material 2128 of the deformable core 2122. The second stiffness is defined by presence of the voids 2130 in the foam material 2128 of the deformable core 2122 within the second portion 2123b. The second stiffness is less than the first stiffness as described in previous implementations. Accordingly, the foam material 2128 of the deformable core 2122 provides the first stiffness in the first portion 2123a, but the presence of the voids 2130 within the foam material 2128 of the deformable core 2122 reduces the stiffness of the cushion 2118 in the second portion 2123b to provide the second stiffness. Stated differently, the foam material 2128 and the voids 2130 cooperate to provide the second stiffness in the second portion 2123b of the cushion 2118.

The voids 2130 may be holes defined in the foam material 2128, such as by molding, cutting, or other methods of shaping or selectively removing portions of the foam material of the deformable core 2122. In one implementation, the deformable core 2122 may be defined in part by an elastomer grid that defines the voids 2130 between intersecting elastomer walls. The magnitude of the second stiffness can be tuned by changing the size and/or spacing of the voids 2130.

The voids 2130 may extend fully through the foam material 2128 of the deformable core 2122 (e.g., from the cover 2124 to the support 1816) or may extend partially through the foam material 2128 of the deformable core 2122. In an alternative implementation, shown in FIG. 21C, the voids 2130 extend partially through the deformable core 2122, from a front surface (e.g., user facing surface that is adjacent to the cover 2124) of the deformable core 2122 to an intermediate location that is located between (e.g., in the depth direction of the cushion 2118) the front surface and a rear surface (e.g., a surface facing toward the support 1816 and which may be located adjacent to the support 1816) of the deformable core 2122. In another alternative implementation, shown in FIG. 21D, the voids 2130 extend partially through the deformable core 2122, from the rear surface to an intermediate location between the rear surface and the front surface. In another alternative implementation, shown in FIG. 21E, the voids 2130 extend partially through the deformable core 2122, from a first intermediate location that is spaced from the front surface to a second intermediate location that is spaced from the rear surface. In the implementations shown in FIGS. 21C-21E, the foam material 2128 is depicted as a single layer, but it could instead include multiples layers, including one or more layers that include the voids 2130, and one or more layers that do not include the voids 2130. For example, in the implementation of FIG. 21C, the foam material 2128 may include a first layer of foam material that is positioned at the front (e.g., closer to the user) and includes the voids 2130, and a second layer that is positioned at the rear (e.g., closer to the support 1816) and does not include the voids 2130. Thus, the deformable core 2122 of the cushion 2118 may include a first layer of foam material and a second layer of foam material, wherein the voids 2130 are formed in the first layer of foam material, and the voids 2130 are omitted from the second layer of foam material.

The voids 2130 may be formed in the foam material of the deformable core 2122 in a manner that defines a gradual stiffness transition between the first stiffness and the second stiffness. In an alternative implementation shown in FIG. 21F, the first portion 2123a has the first stiffness and is free from the voids 2130, the second portion 2123b has a second stiffness that is defined by presence of the voids, where the second stiffness is constant within the second portion 2123b. In a transition portion 2123c, the voids 2130 are configured to define a gradual stiffness transition between the first stiffness and the second stiffness. The gradual stiffness transition can be defined, for example, by varying the areal size, depth, and/or spacing or the voids. In the illustrated implementation, the voids extends from the front surface of the deformable core 2122 toward the rear surface thereof, with the depth of the voids 2130 in the transition portion 2123c being smallest at a first end of the transition portion 2123c adjacent to the first portion 2123a and largest at a second end of the transition portion 2123c adjacent to the second portion 2123b. In an alternative implementation, shown in FIG. 21G, the depth of the voids 2130 is varied as described with respect to FIG. 21F, but the voids 2130 extend from the rear surface of the deformable core 2122 toward the front surface thereof. In another alternative implementation, shown in FIG. 21H, the gradual stiffness transition is defined by varying the areal density of the voids 2130 in the transition portion 2123c from a smallest areal density at the first end of the transition portion 2123c adjacent to the first portion 2123a to a largest areal density at the second end of the transition portion 2123c adjacent to the second portion 2123b. The areal density of the voids 2130 may vary continuously in the transition portion 2123c (e.g., constant linear or non-linear change with respect to unit width between the first portion 2123a and the second portion 2123b) or may change in a step wise manner by forming multiple subregions in the transition portion 2123c that each have a different stiffness that is between the first stiffness and the second stiffness.

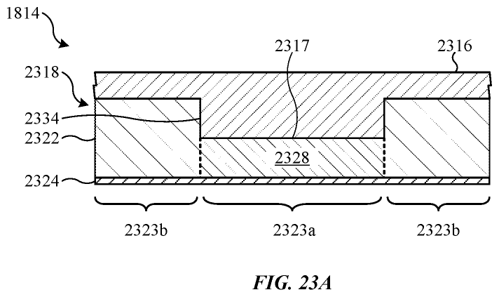

FIG. 22A is a cross-section schematic illustration of part of the chassis 1814 of the wearable device 1800 of FIG. 18 according to a sixth example that includes a cushion 2218 that is molded to provide variable stiffness. The cushion 2218, which is an implementation of the cushion 1818, has a deformable core 2222 and a cover 2224 that surrounds part or all of the deformable core 2222. As will be described further, deformable core 2222 of the cushion 2218 is a molded foam structure that is molded to increase a density of the foam structure in a first portion of the cushion 2218 relative to a second portion of the cushion 2218. The cover 2224 may be present on a user-facing surface of the deformable core 2222, which may have a substantially continuous surface (e.g., free from significant geometric discontinuities) across changes between areas of differing stiffnesses.

The deformable core 2222 includes a first foam material layer 2228a and a second foam material layer 2228b that are configured to define a high stiffness portion 2223a and low stiffness portions 2223b for the deformable core 2222. The first foam material layer 2228a and the second foam material layer 2228b are both present and arranged in layers in the high stiffness portion 2223a. In the illustrated implementation, the first foam material layer 2228a is adjacent to the support 1816 and the second foam material layer 2228b is adjacent to the cover 2224 and the user-facing surface of the cushion 2218, but this configuration may be reversed. The first foam material layer 2228a is not present in the low stiffness portions 2223b in the illustrated implementation and instead the deformable core 2222 includes only the second foam material layer 2228b in the low stiffness portions 2223b.

The first foam material layer 2228a and the second foam material layer 2228b may be formed from foam materials having the same stiffness or from foam materials having different stiffnesses (e.g., the first foam material layer 2228a may have a higher stiffness than the second foam material layer 2228b prior to molding/compression). As an example, the first foam material layer 2228a and the second foam material layer 2228b may be formed from the same foam material. The increased stiffness in the high stiffness portion 2223a is defined by compression of the first foam material layer 2228a and/or the second foam material layer 2228b in the high stiffness portion 2223a.

FIGS. 22B-22C are schematic illustrations showing a first implementation of a molding operation for forming the cushion 2218 of FIG. 22A. The molded foam structure of the deformable core 2222 is formed by compressing the first foam material layer 2228a and the second foam material layer 2228b so that the second foam material layer 2228b is located in the high stiffness portion 2223a of the cushion 2218 and in the low stiffness portions 2223b of the cushion 2218, and the first foam material layer 2228a is located in high stiffness portion 2223a of the cushion and is not located in the low stiffness portions 2223b of the cushion 2218. To compress the high stiffness portion 2223a of the cushion 2218, first foam material layer 2228a and the second foam material layer 2228b are placed in molding tool 2232, as shown in FIG. 22B. Optionally, adhesive may be applied to portions of the first foam material layer 2228a and/or the second foam material layer 2228b.

The molding tool 2232 has a first part 2233a and a second part 2233b that are movable with respect to one another to apply pressure and/or heat to the first foam material layer 2228a and the second foam material layer 2228b. Surfaces of the first part 2233a and the second part 2233b of the molding tool 2232 may be flat or may be configured according to a desired final geometric configuration for the deformable core 2222 of the cushion 2218. The first part 2233a and the second part 2233b of the molding tool 2232 are moved toward each other to apply the pressure and/or heat to the first foam material layer 2228a and the second foam material layer 2228b, thereby changing the shape of the first foam material layer 2228a and/or the second foam material layer 2228b by compressing them and thereby defining the high stiffness portion 2223a and the low stiffness portions 2223b of the deformable core 2222. The deformable core 2222 may then be combined with the cover 2224 (e.g., attached, adhered, etc.) and coupled to the support 1816.

FIGS. 22D-22E are schematic illustrations showing a second implementation of a molding operation for forming the cushion 2218 of FIG. 22A. In this implementation, the molding tool 2232 is used to form the molded foam structure of the deformable core 2222 of the cushion 2218 by compressing a single foam layer 2228c having a variable thickness and a consistent density prior to molding. The single foam layer 2228c is placed in the molding tool 2232 (FIG. 22D) and is then compressed by the molding tool 2232 (FIG. 22E) to define a consistent thickness and variable density for the molded foam structure of the deformable core 2222 of the cushion 2218. The deformable core 2222 may then be combined with the cover 2224 and coupled to the support 1816.

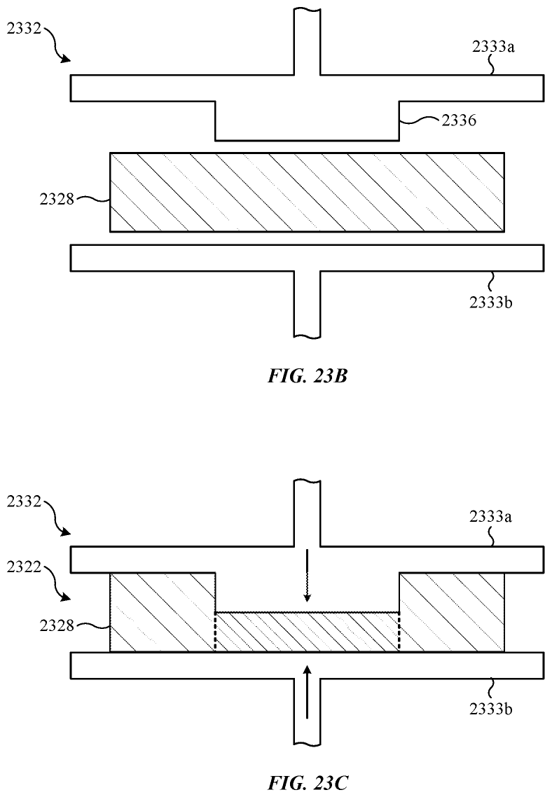

FIG. 23A is a cross-section schematic illustration of part of the chassis 1814 of the wearable device 1800 of FIG. 18 according to a seventh example that includes a cushion 2318 that is molded to provide variable stiffness. The cushion 2318, which is an implementation of the cushion 1818, has a deformable core 2322 and a cover 2324 that surrounds part or all of the deformable core 2322. As will be described further, deformable core 2322 of the cushion 2318 is a molded foam structure that is molded to increase a density of the foam structure in a first portion of the cushion 2318 relative to a second portion of the cushion 2318. The cover 2324 may be present on a user-facing surface of the deformable core 2322, which may have a substantially continuous surface (e.g., free from significant geometric discontinuities) across changes between areas of differing stiffnesses. The cushion 2318 is similar to the cushion 2218 and may be configured and formed in the same manner except as noted herein.

In this implementation, the support 1816 is replaced by a support 2316 that is similar, but includes a surface having a geometric configuration that is complementary to a shape of the deformable core 2322 that is defined by the molding process. In the illustrated implementation, the support 2316 includes a support feature 2317 that extends outward from a nominal surface profile of the support 2316. A foam structure 2328 of the deformable core 2322 has a front surface (e.g., user-facing surface) and a back surface that faces the support 2316. A molded depression 2334 is formed in the back surface of the foam structure 2328, and the support feature 2317 of the support 2316 extends into the molded depression 2334 to provide support for a high stiffness portion 2323a of the foam structure 2328 where the foam structure 2328 is compressed to define the first stiffness. In a low stiffness portions 2323b of the foam structure 2328, the foam structure 2328 is either uncompressed or is compressed to a lesser degree in order to define the second stiffness in the low stiffness portions 2323b, as described in previous implementations. Thus, the foam structure 2328 has a front surface and a back surface, the molded depression 2334 is formed in the back surface of the deformable core 2322 of the foam cushion, and the support 2316 has a support feature 2317 that extends into the molded depression 2334 to provide support for the high stiffness portion 2323a of the cushion 2318.

FIGS. 23B-23C are schematic illustrations showing a molding operation for forming the deformable core 2322 of the cushion 2318 of FIG. 23A. The process of FIGS. 23B-23C is similar to the process of FIGS. 22B-22C except as noted. A molding tool 2332 (e.g., similar to the molding tool 2232) having a first part 2333a and a second part 2333b is used to form the molded foam structure of the deformable core 2322 of the cushion 2318 by compressing the foam structure 2328, which may have a consistent thickness and a consistent density prior to molding. The first part 2333a includes a molding feature 2336 that deviates from a nominal surface shape of the first part 2333a and is shaped similarly to the support feature 2317 (and thus complementary to the depression 2334 of the deformable core 2322). The foam structure 2328 is placed in the molding tool 2332 (FIG. 23B) and is then compressed by the molding tool 2232 (FIG. 23C) to compress the foam structure 2328 in the area of the depression 2334, thereby defining the depression 2334 and creating a region of increased density adjacent to the depression 2334, which thus defines the high stiffness portion 2323a of the deformable core 2322. The deformable core 2322 may then be combined with the cover 2324 and coupled to the support 2316 so that the support feature 2317 is located in the depression 2334 of the deformable core 2322.

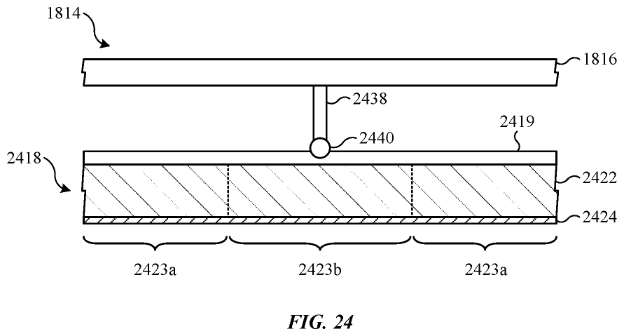

FIG. 24 is a cross-section schematic illustration of part of the chassis 1814 of the wearable device 1800 of FIG. 18 according to an eighth example, which includes a cushion 2418. The cushion 2418 includes a cushion frame 2419, a deformable core 2422, and a cover 2424, which are similar to the cushion frame 1919, the deformable core 1922, and the cover 1924, as previously described. The cushion 2418 is spaced from the support 1816, which allows the cushion to deflect in a manner that is not possible if it is continuously attached to a surface of the support 1816, such as by flexing and curving of the cushion frame 2419. In the illustrated implementation, the cushion 2418 is spaced from the support 1816 by a post 2438 that is connected to the support 1816 and the cushion 2418 to couple the cushion 2418 to the support 1816 and to support the cushion 2418 relative to the support 1816. The cushion 2418 may be coupled to the support 1816 by multiple posts, of which the post 2438 is an example.

In the illustrated implementation, the post 2438 extends outward from the support 1816 and is rigidly coupled thereto (e.g., in a cantilever configuration), but may instead be connected by other means, such as a compliant connection, pivot joint, or other structure. In the illustrated implementation, the post 2438 extends outward from the cushion frame 2419 and is connected thereto by a pivot joint 2440, but may instead be connected by other means, such as a rigid connection, or a compliant connection.

To avoid a localized pressure concentration, the cushion 2418 includes high stiffness portions 2423a and a low stiffness portion 2423b. The low stiffness portion 2423b is positioned adjacent to the post 2438 so that the low stiffness portion 2423b may be located between the body of the user and the post 2438 when the wearable device 1800 is worn. The high stiffness portions 2423a are located adjacent to the low stiffness portion 2423b and outward therefrom so that less force is applied to the body of the user at the low stiffness portion 2423b adjacent to the load transferred between the support 1816 and the cushion 2418 adjacent to the post as compared to the high stiffness portions 2423a, which are not supported by the post 2438 (or another similar structure) directly, thereby allowing the cushion frame 2419 to deflect toward the support 1816 within the high stiffness portions 2423a in response to engagement with the body of the user. This configuration limits the pressure applied to the body of the user by the low stiffness portion 2423b adjacent to the post 2438 where the cushion frame 2419 is unable to deflect or limited in its ability to deflect in response to engagement with the body of the user due to the presence of the post 2438.

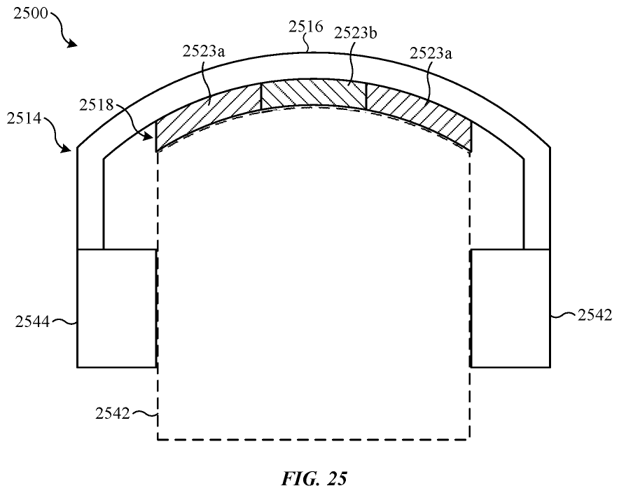

FIG. 25 is a schematic illustration showing a wearable device 2500, which is an example implementation of the wearable device 1800 of FIG. 18. The wearable device 2500 includes a cushion 2518, which can be configured according to the implementations shown in previous examples and implementations. The wearable device 2500 is configured as a headset or headphones type device that is configured to be worn on a head 2542 of a user and to output audio and/or record audio. The wearable device 2500 includes a chassis 2514 having a support 2516 that extends over the head 2542 between two housing parts 2544 that are adjacent to the ears of the user and include electronic components. The cushion 2518 is coupled to the support 2516 and includes high stiffness portions 2523a and a low stiffness portion 2523b, which may be implemented in accordance with previous implementations and examples. The low stiffness portion 2523b is located between the high stiffness portions 2523a and extends over a peak of the head 2542 to reduce the amount of pressure applied to the peak of the head 2542 as this may be a sensitive area for some users.

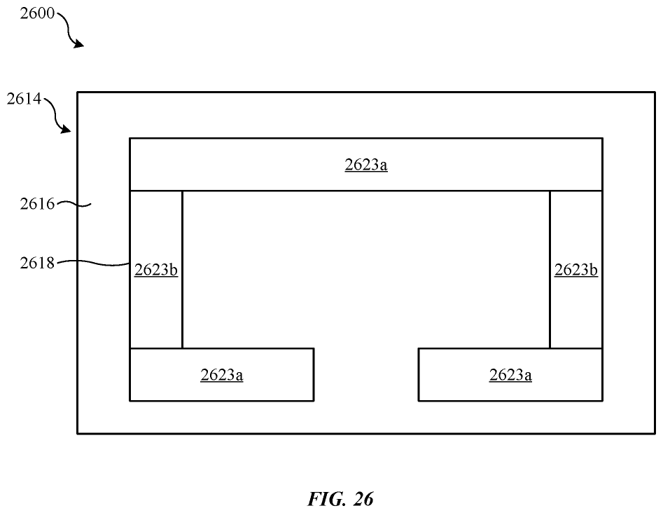

FIG. 26 is a schematic illustration showing a wearable device 2600, which is an example implementation of the wearable device 1800 of FIG. 18. The wearable device 2600 is configured as a head-mount display for presenting simulated reality content to a user and may engage a face of the user. The wearable device 2600 includes a cushion 2618, which can be configured according to the implementations shown in previous examples and implementations, and is connected to a chassis 2614 having a support 2616, which may be a surface that extends part way around an eye chamber area of the wearable device 2600 where display components are located. The cushion 2618 is coupled to the support 2616 and includes high stiffness portions 2623a and low stiffness portions 2623b, which may be implemented in accordance with previous implementations and examples. As an example, the low stiffness portions 2623b may be located laterally outward from the eyes of the user to avoid loading these areas. Additional regions where the high stiffness portions 2623a are located may be replaced with the low stiffness portions 2623b, such as above the nose of the user and on the cheeks of the user below the eyes of the user.

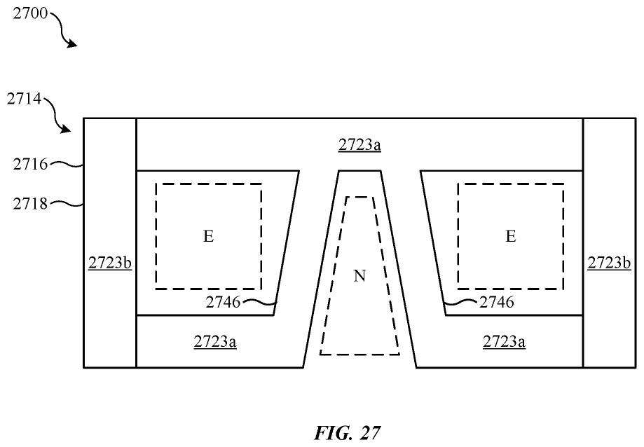

FIG. 27 is a schematic illustration showing a wearable device 2700, which is an example implementation of the wearable device 1800 of FIG. 18. The wearable device 2700 is configured as a head-mount display for presenting simulated reality content to a user and may engage a face of the user, and is illustrative of variations in facial interface shapes that may be used in a head-mount display. The wearable device 2600 includes a cushion 2718, which can be configured according to the implementations shown in previous examples and implementations, and is connected to a chassis 2714 having a support 2716, which may be a surface that extends part way around an eye chamber area of the wearable device 2700 where display components are located. The cushion 2718 is coupled to the support 2616 and includes high stiffness portions 2723a and low stiffness portions 2723b, which may be implemented in accordance with previous implementations and examples. In the illustrated implementation, part of the loading is carried by cushion portions 2746 that extend between the nose N and the eyes E of the user, and these portions of the cushion 2718 may be defined as the high stiffness portions 2723a. The low stiffness portions 2723b may be located laterally outward from the eyes E and optionally in other locations as previously described.

In the description, terms such as “up,” “down,” “left,” “right,” “forward,” and “rearward,” are used for convenience and explanatory purposes to aid in understanding of the subject matter. It should be understood that described components are not necessarily limited to such positions or directions of movement.

In implementations in which the device 100 is a head-mounted simulated reality device, it may be configured to be worn on the head of a user and include components that are configured to display content to the user. Components of the device 100 be configured to track motion of parts of the user's body, such as the user's head and hands. Motion tracking information that is obtained by components of the head-mounted device can be utilized as inputs that control aspects of the generation and display of the content to the user, so that the content displayed to the user can be part of a simulated reality experience in which the user is able to view and interact with virtual environments and virtual objects. As will be explained further herein, simulated reality experiences include display of simulated reality content independent of the surrounding physical environment (e.g., virtual reality), and display of computer generated content that is overlaid relative to the surrounding physical environment (e.g., augmented reality).

In reference to computing devices such as the device 100, the description herein relates to simulated environments, which are distinct from physical environments. The term physical environment is defined herein as a physical world that does not require the use of an electronic system to see or interact with using their senses of sight, touch, hearing, taste, and smell. Physical environments may include, for example, places, objects, and people. In contrast, a simulated environment refers is wholly or partially generated by a computing device. Use of an electronic system is required to see a simulated environment and to interact with it.

As an example, a computing device can track a portion of a person's physical motions and use those tracked motions to allow the user to interact with objects that exist only in the simulated environment, and not in the physical environment. As an example, tracked user motions in the physical environment may be imported into the simulated environment to control motion of a person or object in the simulated environment. As an example, interactions of the user with simulated objects can be modeled using a physics engine that is based on the laws of physics. In some implementations, movements of the person's head or movements of a device are tracked and used to change the way that graphical and audio content is presented, for example, in accordance with changes in a view angle.

Multiple aspects of the physical world may be incorporated in a simulated environment that is generated by a computing device. Three-dimensional visual and audio content may be generated to allow the person to see and hear the simulated environment. In some implementations, touch, taste, and smell may also be simulated. In some implementations, aspects of the physical environment are presented in combination with objects of the simulated environment, such as through visual pass through or audio transparency.

A virtual reality (VR) environment is an example of a simulated reality environment. VR refers to a simulated environment that is separate from the physical environment and is intended to present visual and/or audio content to the user in lieu of presenting the physical environment to the user. For example, visual content that is presented to the user may be wholly computer generated, without incorporating features from the physical environment. A VR environment may allow a person to sense virtual objects and interact with virtual objects. A person's movements in the physical environment may be simulated in a VR environment.

In contrast to a VR environment, which is designed to be based entirely on computer-generated sensory inputs, a mixed reality (MR) environment refers to a simulated environment that is designed to incorporate sensory inputs from the physical environment, or a representation thereof, in addition to including computer-generated sensory inputs (e.g., virtual objects).

A mixed reality (MR) environment is another example of a simulated reality environment. In an MR environment simulated features may be generated in dependence on features from the physical environment. Motion and orientation of the person may be tracked and used as a basis for generating the MR environment. Simulated features may change in response to changes in the physical environment, such as by changing the location of a simulated object so that it moves in correspondence with a physical object or appears to replace a physical object. Display locations of simulated objects may change in correspondence with a viewing direction of the person so that simulated objects appear stationary relative to the physical environment.

An augmented reality (AR) environment is another example of a simulated reality environment. In an AR environment, features from the physical environment may be presented in combination with simulated features. As an example, one or more virtual objects may be superimposed over an actual view of a physical environment, or a representation of the physical environment. Some AR systems have a transparent or translucent display through which a person may directly view the physical environment in combination with virtual objects that are presented on the transparent or translucent display. Some AR systems have an opaque display and one or more cameras, and virtual objects are superimposed onto images or video of the physical environment. This type of display may by referred to as “pass-through video.” Other AR systems may have a projection system that projects virtual objects into the physical environment to superimpose the virtual objects on the physical environment.

The term AR environment may also refer to a simulated environment in which a representation of a physical environment is changed using computer-generated sensory information. As one example, during presentation of pass-through video, a system may transform still or video images to show a different viewpoint that the one captured by the cameras. As another example, graphical modifications may be applied to a video-based representation a physical environment, such as by selectively enlarging, shrinking, or removing certain features, or by presenting features in a non-photorealistic way.

An augmented virtuality (AV) environment is another example of a simulated reality environment. In an AV environment, a computer-generated environment incorporates one or more sensory inputs from the physical environment, such as representations of physical environment characteristics. As an example, a computer-generated environment may be created using photorealistic elements from the physical world, such as images of people's faces applied to virtual avatars. As another example, virtual objects may be modified according to characteristics of physical objects, such as color and shape. As another example, environmental conditions, such as weather or sunlight angle, may be recognized using sensors or other data sensors, and used as a basis for modifying a simulated environment.

A variety of differently configured electronic device architectures can be used to experience simulated environments. One example is a head-mounted system, which may have one or more speakers and an integrated or detachable opaque display. The head-mounted system may incorporate sensors that perceive the physical environment, such as cameras and microphones. Alternatively, the head-mounted system may have a transparent or translucent display coupled with optical images that cause content to be displayed so that it can be seen by the person using the device. Another example is a projection-based that projects graphical images onto a person's retina. These images may superimpose simulated objects onto the person's view of the physical environment. Other devices that may be used include heads-up displays, smartphones, tablets, and desktop/laptop computers.

The technology described herein may be implemented in a manner that includes use of personal information, such as information that identifies a person. This information may be used to enhance a user's experience or to improve the function of systems such as the device 100, for example, by allowing access to an account associated with the user, or storing information, such as a user profile, that includes custom settings or preferences. The information may include demographic data, location data, contact information, health and wellness-related information, and/or other types of information.

Entities that implement this technology should only collect and/or store personal information after receiving permission to do so from the user. Moreover, personal information should only be collected and used to the extent necessary, and only in support of features that are beneficial to users. To the extent that personal information is collected and/or stored, implementers should adhere to best practices as to safeguarding the privacy of the information. As an example, applicable government regulations and/or industry standard privacy policies and practices should be met or exceeded. All such policies and practices should be clearly documented and made available to users. Any storage of personal information should be managed in a manner that minimizes risks of unintentional or unauthorized access or use. As examples, data collection can be limited, data can be deleted when no longer needed, data can by anonymized, and data can be aggregated across users instead of stored in association with a particular user.

Users should be provided with a mechanism by which use of personal information can be limited or eliminated. As an example, users should be allowed to opt out of collection and storage of personal information. This functionality should be provided at an application level and at a feature level. Thus, a user should be permitted to allow use of personal information to enable certain features, and block use of personal information with respect to other features. In addition, users should be allowed to limit the time period over which personal information will be stored, and users should be allowed to request deletion of their personal information at any time. Also, users can be provided notifications when personal information will be used. As an example, an application may output a notification prior to accessing or storing personal information.

The technology described herein can also be used without storing and accessing personal information. As an example, any information required for operation of the technology can be obtained from the user at the time it is needed, without associating the information with the user in a personally identifiable manner, and without subsequently storing the information.

What is claimed is:

1. A wearable device, comprising:
a support; and
a cushion that is coupled to the support and configured to engage an upper facial region, a lower facial region, and side facial regions to block environmental light, the cushion including:
a first portion that is configured to engage the upper facial region, the first portion having a first stiffness,
a second portion configured to engage the lower facial region, the second portion having a second stiffness, and the first stiffness is at least four times greater than the second stiffness, and
third portions that are configured to engage the side facial regions.

2. The wearable device of claim 1, wherein the third portions have a third stiffness, the first stiffness being at least four times greater than the third stiffness.

3. The wearable device of claim 1, further comprising:
wherein the first portion includes a right upper subportion having the first stiffness, a left upper subportion having the first stiffness, and a central upper subportion having a fourth stiffness, the first stiffness being at least four times greater than the fourth stiffness,
wherein the right upper subportion and the left upper subportion are configured to engage, respectively, a right upper facial subregion and a left upper facial subregion above, respectively, a right eye and a left eye,
wherein the central upper subportion is configured to engage with the fourth stiffness a central upper facial subregion between the right upper facial subregion and the left upper facial subregion, and
wherein the second portion includes a right lower subportion having the second stiffness and a left lower subportion having the second stiffness, wherein the right lower subportion and the left lower subportion are configured to engage, respectively, a right lower facial subregion and a left lower facial subregion below, respectively, the right eye and the left eye of the user.

4. The wearable device of claim 1, wherein the first portion of the cushion includes a first foam material that provides the first stiffness, and the second portion of the cushion includes a second foam material that provides the second stiffness.

5. The wearable device of claim 4, wherein the first foam material and the second foam material have different densities and are formed from a common material type.

6. The wearable device of claim 4, wherein the first foam material and the second foam material are formed from different material types.

7. The wearable device of any of claim 1, wherein the cushion includes a first foam layer and a second foam layer, the first foam layer and the second foam layer cooperate to provide the first stiffness in the first portion of the cushion, and the first foam layer provides the second stiffness in the second portion of the cushion.

8. The wearable device of claim 7, wherein the cushion has a consistent depth in the first portion of the cushion and in the second portion of the cushion, and the second foam layer is not present in the second portion of the cushion.

9. The wearable device of claim 1, wherein the cushion includes a transition portion having a gradual stiffness transition between the first stiffness and the second stiffness.

10. The wearable device of claim 9, wherein the first portion of the cushion includes a first foam material that provides the first stiffness, the second portion of the cushion includes a second foam material that provides the second stiffness, and the first foam material overlaps the second foam material in the transition portion to define the gradual stiffness transition between the first stiffness and the second stiffness.

11. A wearable device, comprising:
a support; and
a cushion that is coupled to the support and configured to engage an upper facial region, a lower facial region, and side facial regions to block environmental light, the cushion including:
a first portion that is configured to engage the upper facial region, the first portion having a first stiffness,
a second portion configured to engage the lower facial region, the second portion having a second stiffness, the first stiffness is greater than the second stiffness, and voids are formed in the second portion to define the second stiffness.

12. The wearable device of claim 11, wherein the cushion includes a foam material that provides the first stiffness in the first portion of the cushion, and the foam material and the voids cooperate to provide the second stiffness in the second portion of the cushion.

13. The wearable device of claim 12, wherein the voids extend through the foam material from a front surface of the foam material to the support.

14. The wearable device of claim 12, wherein the voids extend partially through the foam material.

15. The wearable device of claim 11, wherein the cushion includes a transition portion in which the voids are configured to define a gradual stiffness transition between the first stiffness and the second stiffness.

16. The wearable device of claim 11, wherein the cushion includes a molded foam structure having the first portion and the second portion, the first portion having a first density, and the second portion having a second density, wherein the first density is greater than the second density.

17. A wearable device, comprising:
a support; and
a cushion that is coupled to the support, the cushion including a molded foam structure having a first portion and a second portion, the first portion having a first density, and the second portion having a second density, wherein the first density is greater than the second density.

18. The wearable device of claim 17, wherein the molded foam structure is formed by compressing a first foam layer and a second foam layer so that the first foam layer is located in the first portion of the cushion and in the second portion of the cushion, and the second foam layer is located in first portion of the cushion and is not located in the second portion of the cushion.

19. The wearable device of claim 17, wherein the molded foam structure is formed by compressing a foam layer having a variable thickness and a consistent density to define a consistent thickness and variable density for the molded foam structure.

20. The wearable device of claim 17, wherein the molded foam structure has a front surface and a back surface, a molded depression is formed in the back surface of the molded foam structure, and the support has a support feature that extends into the molded depression to provide support for the first portion of the cushion.
